(19) United States
(12) Patent Application Publication
(10) Pub. No.: US 2006/0217826 A1
(43) Pub. Date: Sep. 28, 2006

(54) Image processing apparatus and a method therefor

(75) Inventor: Akihiro Matsuya, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/385,311

(22) Filed: Mar. 21, 2006

(30) Foreign Application Priority Data
Mar. 23, 2005 (JP) 2005-084514

(51) Int. Cl. G06F 9/00

(52) U.S. Cl. 700/90

(57) ABSTRACT

An image processing apparatus by which in performing a setting as to a registration of application data to a database, a type of an object to be registered to the database can be selected. For example, if a photograph mode is selected, among vectorized data, a photographic object is registered to the database, and objects of the other attribute are defined as NULL and are registered to the database with respect to positional information thereof. Further, a registration period can be set for each attribute.

### BACKGROUND OF THE INVENTION

1. Field of the Invention

The present invention relates to an image processing apparatus and a method implemented within the apparatus. More specifically, for example, the present invention relates to image processing in which electronic data such as a document is reusably registered in a database.

2. Description of the Related Art

Recently, environmental problems have been recognized to be more and more serious, and accordingly, “paperless” business practices has been rapidly promoted. There are various kinds of methods of creating a paperless office environment. First, for example, there is a method in which documents stored and stacked by using a binder and the like are read by a scanner or other similar devices, and data of the read documents is converted into a compact-size file in a format such as a portable document format (PDF), as raster data of an image of the read document or code data of the raster data (hereinafter collectively referred to as “image data”), and the file is stored in a storage device (see, for example, Japanese Patent Application Laid-Open No. 2001-358863).

There is another method of creating a paperless office environment in which an original data file of a document or an image is stored in a storage device by using a function-enhanced recording apparatus or a multi-function peripheral (MFP) device. In printing the original data file, pointer information of the storage device that includes the original data file in a storage area is recorded onto a cover page of a print document or into print information of the print document, as adjunct information (see, for example, Japanese Patent Application Laid-Open No. 10-285378). In this method, the utilization of the pointer information enables a direct and immediate access to the original data file. In addition, the original data file can be reused (edited, printed, or the like), by handling the original data file as input image data. Thus, an amount of stored print documents (paper) can be suppressed to a minimum. Also in this method, in order to utilize the original data file stored in the storage device from a different other network domain, data that is processed as reusable information is registered in the database for retrieval, as well as storing the original data file in the database. Note that the data processed into reusable information can be used as index information for retrieval for the original data file based on the print document.

As mentioned above as an example, a system has been implemented for practical use that enables a data access to original electronic information (such as the original data file), from document information of the print document. Such a system has an advantage and convenience such that the original electronic information can be handled with the print document as a key, via a server (or from the storage device). However, if the quantity of registered original electronic information increases, a storage capacity of the server that manages the electronic information needs to be increased to an appropriate level. Further, the information desired to be reused (or edited, printed, or the like) may not necessarily be all the registered information. That is, some registered information cannot be reused or edited for one part thereof only. In other words, a status of use of the registered information depends on the desire of a person who produces the registered information as a registrant.

Additionally, U.S. Patent Application Publication No. US 2004/0223197 A1 teaches an image processing method which is directed to overcoming the need for the user to directly select data to be registered for each sheet. Here, region segmentation information obtained in a block selection step and an input image are composited, the composite image is displayed on an operation screen of an MFP, and a rectangular block to be vectorized is designated as a specific region from the displayed region segmentation information. As a method of designating the specific region, for example, the user designates one or a plurality of rectangular blocks in an image using a pointing device. However, even though the aforementioned method is directed to improvement of the selection of the data to be registered, it still requires simplification of operability in the selection of the data to be registered.

### SUMMARY OF THE INVENTION

The present invention is directed to effectively and appropriately suppressing a large amount of electronic data reusably registered into a database and to improve selection of data to be registered.

According to one embodiment of the present invention, an image processing apparatus is provided which includes a print instruction unit configured to instruct printing of application data; a registration setting unit configured to register as to whether the application data is registered to a database; an attribute selection unit configured to select an attribute of data to be registered to the database when a registration is set by the registration setting unit, the attribute including a type of data; a conversion unit configured to convert the application data, which have the attribute selected by the attribute selection unit, into data to be registered of another data format; and a registration unit configured to register the data converted by the conversion unit into the database when the registration is set by the registration setting unit.

According to an aspect of the embodiment, the selected attribute is a type of an object. According to another aspect of the present invention, the registration unit registers the converted data with the application data.

According to another aspect of the embodiment, the apparatus further includes a time period setting unit configured to set a time period of registration of the converted data, wherein the registration unit registers the converted data with data of the registration period set by the time period setting unit. Also, according to another aspect of the embodiment, the time period setting unit sets the registration period for each attribute.

According to yet another aspect of the embodiment, an entity of the object corresponding to the attribute whose registration period has already elapsed is erased from the data registered to the database. Moreover, according to another aspect of the embodiment, the processing apparatus may also include an access frequency setting unit configured to set an access frequency for erasing the registered data from the database, wherein the registration unit registers the converted data with data of the access frequency set by the access frequency setting unit.

Furthermore, according to another aspect of the embodiment, the registered data that is smaller than the access frequency set by the access frequency setting unit is erased from the database. According to another aspect of the embodiment, the access frequency setting unit sets the access frequency with respect to each attribute. Additionally, according to yet another aspect of the embodiment, the conversion unit converts the application data having the attribute into vector data.

According to another embodiment of the present invention, an image processing method of an image processing apparatus having a print instruction unit configured to instruct printing of application data is provided. The method includes setting whether the application data is registered to a database; selecting an attribute of data to be registered to the database when a registration is set, the attribute including a type of data; converting the application data, which have the attribute selected, into data to be registered of another data format; and registering the converted data into the database when the registration is set.

According to another embodiment of the present invention, a computer-executable program for controlling an image processing apparatus is provided. The program includes computer-executable instructions for setting whether application data is registered to a database; computer-executable instructions for selecting an attribute of data to be registered to the database when a registration is set, the attribute including a type of data; computer-executable instructions for converting the application data, which have the attribute selected, into data to be registered of another data format; and computer-executable instructions for registering the data converted into the database when the registration is set.

According to yet another embodiment of the present invention, an image processing apparatus for processing image data is provide which includes an attribute selection unit configured to select an attribute to be registered to a database based on user's instruction, the attribute including a type of data; a conversion unit configured to convert an area of the image data into object data to be registered, wherein the area of the image data have the attribute selected by said attribute selection unit; and an output unit configured to output the object data converted by said conversion unit to the database for the registration.

Additionally, according to another embodiment of the present invention, an image processing method for processing image data is provided which includes selecting an attribute to be registered to a database based on user's instruction, the attribute including a type of data; converting an area of the image data into object data to be registered, wherein the area of the image data have the attribute selected; and outputting the object data converted by the conversion unit to the database for the registration.

And finally, according to still yet another embodiment of the present invention, a computer-readable recording medium having computer-executable instructions for executing an attribute selection step for selecting an attribute to be registered to a database based on user's instruction, the attribute including a type of data; a conversion step for converting an area of image data into object data to be registered, wherein the area of the image data have the attribute selected in said attribute selection step; and an output step for outputting the object data converted by said conversion unit to the database for the registration.

According to the aforementioned embodiments of the present invention, the data amount of the electronic data reusably registered into the database can be effectively and appropriately suppressed.

Further embodiments, aspects and features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate numerous embodiments, features and aspects of the invention and, together with the description, serve to explain the principles of the invention.

FIG. 1 is a block diagram showing an example of a configuration of an image processing system according to a first embodiment of the present invention.

FIG. 2 is a block diagram showing an example of a configuration of a multi-function peripheral (MFP) device.

FIG. 3 is a schematic diagram explaining an outline configuration of a processing module that operates on a client computer, in a case where application data is subjected to a print processing.

FIG. 4 is a block diagram showing a detailed exemplary configuration of the processing module as shown in FIG. 3.

FIG. 5 is a schematic diagram showing one example of a user interface (dialog) for performing settings for printing and registration.

FIG. 6 is a flow chart showing an example of processing performed by a spooler.

FIG. 7 is a flow chart showing an example of processing performed by a spool file manager.

FIG. 8 is a diagram showing one example of information that is notified to a despooler from the spool file manager.

FIG. 9 is a diagram showing one example of a print setting dialog that is displayed when a “Detailed Settings” key is pressed.

FIG. 10 is a diagram showing one example of a print setting dialog that is displayed when a “Detailed Settings” key is pressed.

FIG. 11 is a diagram showing one example of vectorized data when a full registration mode is set.

FIG. 12 is a diagram showing one example of vectorized data when a full registration mode is set.

FIG. 13 is a diagram showing a file format obtained by combining the vectorized data and application data of the original.

FIG. 14 is a flow chart showing the vectorization processing performed by the spooler as shown in FIG. 6, in detail.

FIG. 15 is a diagram showing one example of an operation screen showing a state in which area division information obtained by a block selection (BS) processing and an input image are rasterized.

FIG. 16A and FIG. 16B are diagrams that respectively show one example of a result of the block selection processing.

FIG. 17 is a flow chart showing the vectorization processing in detail.

FIG. 18 is a diagram that explains a vertex extraction processing performed in the course of the vectorization.

FIG. 19 is a diagram that explains a processing for linking contours performed in the course of the vectorization.

FIG. 20 is a flow chart showing processing for grouping vector data produced by the vectorization.

FIG. 21 is a flow chart showing processing for extracting a graphic primitive.

FIG. 22 is a diagram showing a format of intermediate data that indicates a result of the vectorization processing.

FIG. 23 is a flow chart showing processing for conversion of the data into the data of an application data format.

FIG. 24 is a flowchart showing a detail of an exemplary processing for producing a document structure tree.

FIG. 25 is a diagram showing one example of an input image.

FIG. 26 is a diagram showing the document structure tree obtained from the image as shown in FIG. 25.

FIG. 27 is a diagram showing a file format of vectorized data according to a second embodiment of the present invention.

FIG. 28 is a diagram showing one example of a print setting dialog displayed when a “Detailed Settings” key is pressed, according to a third embodiment of the present invention.

FIG. 29 is a diagram showing one example of a print setting dialog displayed when a “Detailed Settings” key is pressed, according to the third embodiment of the present invention.

FIG. 30 is a diagram showing one example of a print setting dialog displayed when a “Detailed Settings” key is pressed, according to the third embodiment of the present invention.

FIG. 31 is a diagram showing one example of vectorized data for which a registration period is specified.

FIG. 32 is a flow chart that explains an exemplary management of the registration period performed by a database server.

FIG. 33 is a diagram showing one example of a print setting dialog displayed when a “Detailed Settings” key is pressed, according to a fourth embodiment of the present invention.

FIG. 34 is a diagram showing one example of a print setting dialog displayed when a “Detailed Settings” key is pressed, according to the fourth embodiment of the present invention.

FIG. 35 is a diagram showing one example of vectorized data for which a registration period of a photographic object is specified.

FIG. 36 is a flow chart that explains an exemplary management of the registration period performed by a database server.

FIG. 37 is a diagram that explains a photographic object in a NULL state.

FIG. 38 is a diagram showing an example in which a “Frequency Setting” key is provided instead of a “Time Period Setting” key, in the print setting dialog as shown in FIG. 34.

FIG. 39 is a diagram showing one example of vectorized data for which an access frequency of the photographic object is specified.

FIG. 40 is a flow chart that explains an exemplary management processing of registered data performed by the database server.

### DETAILED DESCRIPTION OF THE EMBODIMENTS

Numerous exemplary embodiments of the present invention will now be described in detail with reference to the drawings. It should be noted that the relative arrangement of the components, the numerical expressions and numerical values set forth in these embodiments are intended not limit the scope of the present invention unless it is specifically stated otherwise.

### First Exemplary Embodiment

[Exemplary Image Processing System]

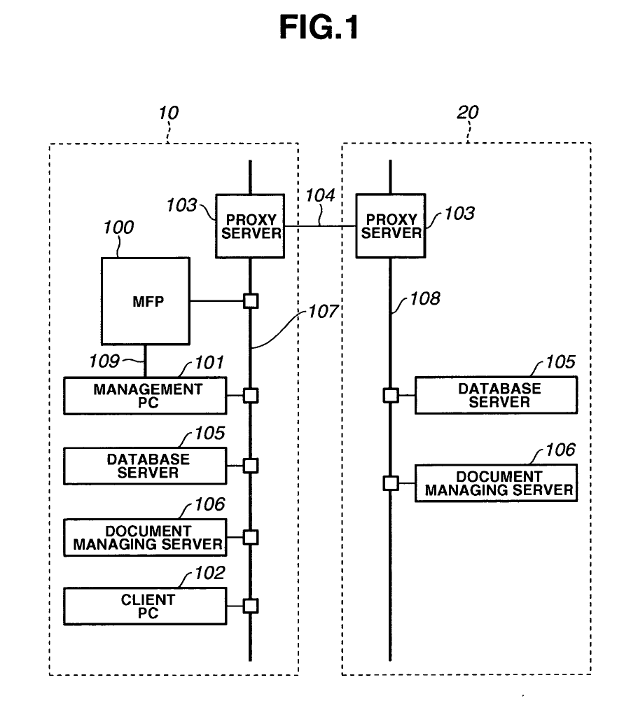

FIG. 1 is a block diagram showing an example of a configuration of an image processing system according to a first embodiment of the present invention. The image processing system is implemented under an environment in which offices (or a plurality of segments similar to such office) 10 and 20 are mutually connected via a network 104 (e.g. wide area network (WAN)).

There are connected to a LAN 107, which is structured in the office 10, a multi-function peripheral (MFP) device 100, a management PC 101 that controls the MFP 100, a client PC 102, a document management sever 106, a database server 105 that is managed by the document management sever 106, and the like. The Office 20 is structured in a substantially same manner as the office 10. There are connected to a LAN 108, which is structured in the office 20, the document management sever 106, the database server 105 that is managed by the document management sever 106, and the like. The LAN 107 of the office 10 and the LAN 108 of the office 20 are mutually connected via a proxy server 103 that is connected to the LAN 107, the WAN 104, and the proxy server 103 that is connected to the LAN 108.

The MFP 100 reads a document image and performs a part of an image processing by which the read image is processed. An image signal that is outputted from the MFP 100 is inputted to the management PC 101, via a communications line 109. The management PC 101 is a common type personal computer (PC). The management PC 101 is provided with an image processing unit structured by a hard disk and a memory in which the image is stored and hardware or software; a monitor such as a CRT, an LCD, and the like; an input unit such as a mouse, keyboard, and the like. One part of the structure of the management PC 101 is constituted in the MFP 100. In addition, the MFP 100 functions as a printer that interprets print data of a page description language (PDL) format that is received from the client PC 102 or a general purpose PC (not shown) (the print data described here is hereinafter referred to as “PDL data”) and prints the image onto a recording paper.

Note that hereinbelow, an explanation is made as to an example in which the management PC 101 executes a detection processing and the like as described below. However, the MFP 100 may execute the processing performed by the management PC 101.

[Exemplary MFP]

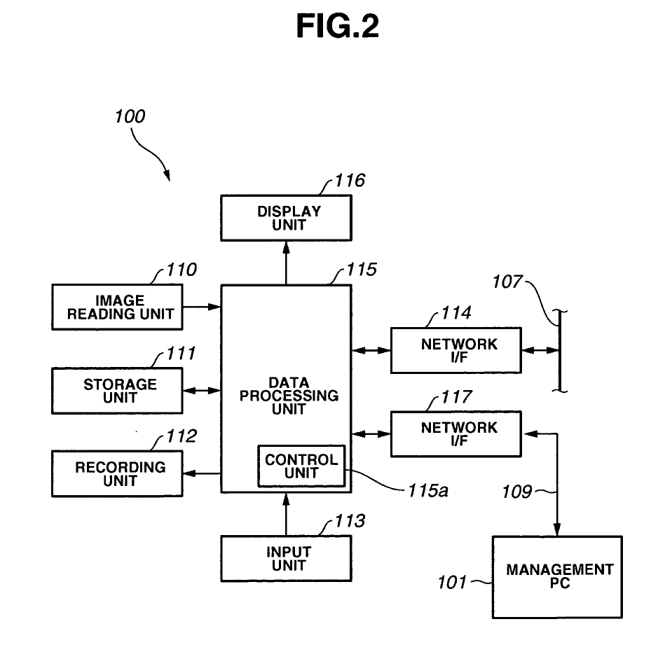

FIG. 2 is a block diagram showing an example of a configuration of the MFP 100. An image reading unit 110 that includes an auto document feeder (ADF) irradiates each image of one single original or a plurality of stacked originals with a light source, forms a reflected image from an original onto a solid-state image pickup element with using a lens, and obtains an image reading signal (for example, 600 dpi, 8-bit) arranged in an order of rasterization, from the solid-state image pickup element. In copying the original, the image reading signal is converted into a recording signal by a data processing unit 115. In a case of copying the original onto a plurality of recording papers, the recording signals for one page of the original is temporarily stored in a storage unit 111, and after that, the recording signals are repeatedly outputted to a recording unit 112, and thus the images are formed onto a plurality of recording papers.

Meanwhile, the PDL data that is output from the client PC 102 is input to a network interface (I/F) 114 via the LAN 107. Then, the PDL data is converted into raster data recordable by a data processing unit 115, and after that, the PDL data is formed as an image onto the recording paper by the recording unit 112.

An instruction issued by an operator to the MFP 100 is performed through a key operation unit provided and installed to the MFP 100 and an input unit 113 of the management PC 101 that is constituted by a keyboard and a mouse or the like. Operational inputs and a state of image processing, and the like are performed by a display unit 116.

The operation of the MFP 100 is controlled by a control unit 115a constituted by a one-tip microcontroller, for example, installed in the data processing unit 115. Note that the storage unit 111 can be controlled from the management PC 101. Sending and receiving of the data between the MFP 100 and the management PC 101, and control of the data as well, are performed via a network I/F 117 and a signal line 109, which directly connects the MFP 100 and the management PC 101.

Note that the MFP 100 may include an interface, as one part of the input unit 113, for obtaining image data from an image pickup apparatus such as a digital still camera and a digital video camera, a portable terminal apparatus such as a portable data assistant device, a facsimile, and the like.

[Exemplary Client PC]

(Exemplary Configuration of a Processing Module)

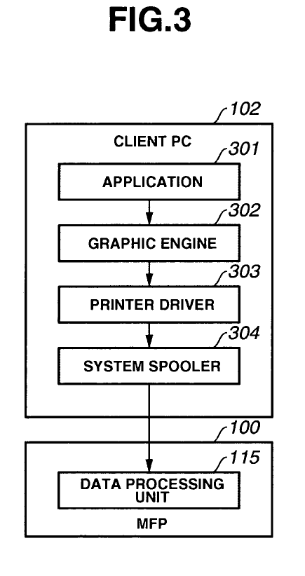

FIG. 3 is a schematic diagram explaining an outline configuration of an exemplary processing module that operates on the client PC 102, in a case where application data is subjected to a print processing. The processing module performs a registration, in performing a printing operation by a printer driver 303, of application data into the MFP 100, as the retrievable or reusable application data. Note that application 301, a graphic engine 302, the printer driver 303, and a system spooler 304, which are shown in FIG. 3, exist as a file stored in a memory (not shown) in the client PC 102. In addition, the processing module is a program module (data processing module) executed by an operating system (OS) or by a module that uses the module, when the processing module is to be executed. Further, the application 301 and the printer driver 303 can be installed to a medium including a CD-ROM and to a storage device such as a hard disk in the client PC 102 via the LAN 107, for example, from a device external to the client PC 102.

The graphic engine 302 that receives an instruction for print processing from the application 301 activates the printer driver 303 provided for each MFP 100 or each recording unit 112, and also supplies an output from the application 301 to the printer driver 303. In other words, the graphic engine 302 converts a graphic device (GDI) interface function into a device driver interface (DDI) function, and also supplies the DDI function to the printer driver 303.

The printer driver 303 converts the DDI function received from the graphic engine 302 into a control command that can be recognized by the data processing unit 115 of the MFP 100 (for example, the control command of the PDL format), and thus produces the PDL data. The PDL data is temporarily stored in a system spooler 304 controlled over and managed by the OS, and then is sent to the data processing unit 115 of the MFP 100, and thus, the PDL data is subjected to printing.

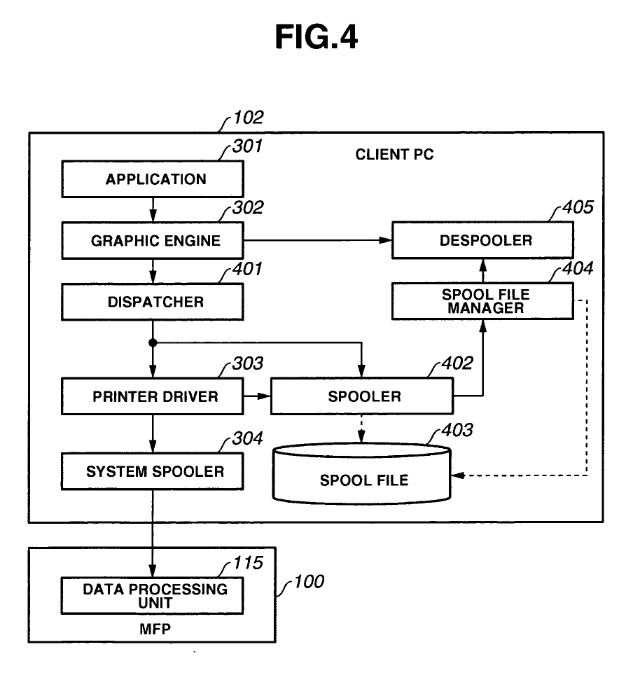

FIG. 4 is a block diagram showing a detailed configuration of the exemplary processing module as shown in FIG. 3. More specifically, the block diagram as shown in FIG. 4 shows a configuration in which a spool file 403, which is constituted by an intermediate code, is temporarily produced when a print command is sent from the graphic engine 302 to the printer driver 303. Note that the processing module as shown in FIG. 4 can edit or process a content of the spool file 403, and thus implements a function that the application 301 does not have such as scaling (enlargement or reduction) and an N-up printing, in which a plurality of pages are laid out in one single page to reduce-print, of the print data outputted from the application 301. In other words, the configuration of the processing module as shown in FIG. 4 is expanded so as to spool the intermediate code data.

In FIG. 4, a dispatcher 401 receives a print command from the graphic engine 302. If the received print command is a print command issued from the graphic engine 302 to the application 301, the dispatcher 401 loads a spooler 402 stored in a hard disk and the like (not shown) into a RAM (not shown), and then sends the print command to the spooler 402, not to the printer driver 303.

The spooler 402 converts the received print command into the intermediate code, for each page. In addition, the spooler 402 outputs the intermediate code to the spool file 403 allocated to the hard disk (or the RAM), and obtains various settings related to print/registration data set to the printer driver 303, and then stores the obtained settings into the spool file 403. Further, the spooler 402 loads a spool file manager stored in the hard disk and the like into the RAM and then notifies a state of production of the spool file 403 to the spool file manager 404.

Then, the spool file manager 404 determines whether the printing or registration can be performed, in accordance with a content of the settings stored in the spool file 403. If it is determined that the printing and registration can be performed by using the graphic engine 302, the spool file manager 404 loads a despooler 405 into the RAM, and at the same time, issues an instruction to the despooler 405 for print processing of the intermediate code described in the spool file 403 and sending of the original data and the application data that can reuse the original data.

The despooler 405 edits and processes the intermediate code stored in the spool file 403 in accordance with the content of the settings stored in the spool file 403, and supplies the intermediate code again to the graphic engine 302.

The dispatcher 401, when the received print command is the print command issued from the despooler 405 to the graphic engine 302, sends the print command to the printer driver 303, not to the spooler 402. The printer driver 303, as described above, produces the PDL data and outputs the produced PDL data to the MFP 100 via the system spooler 304.

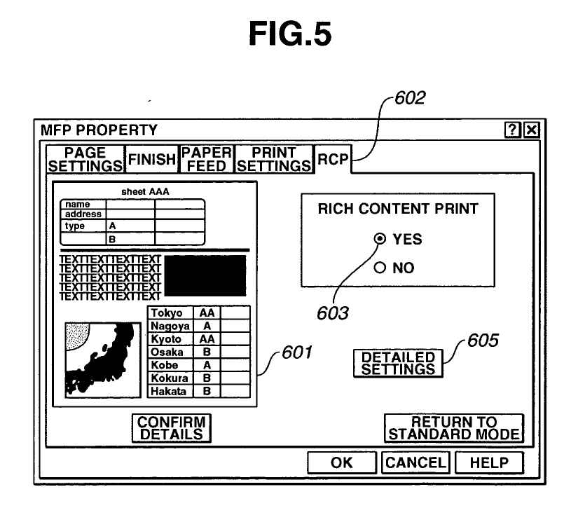

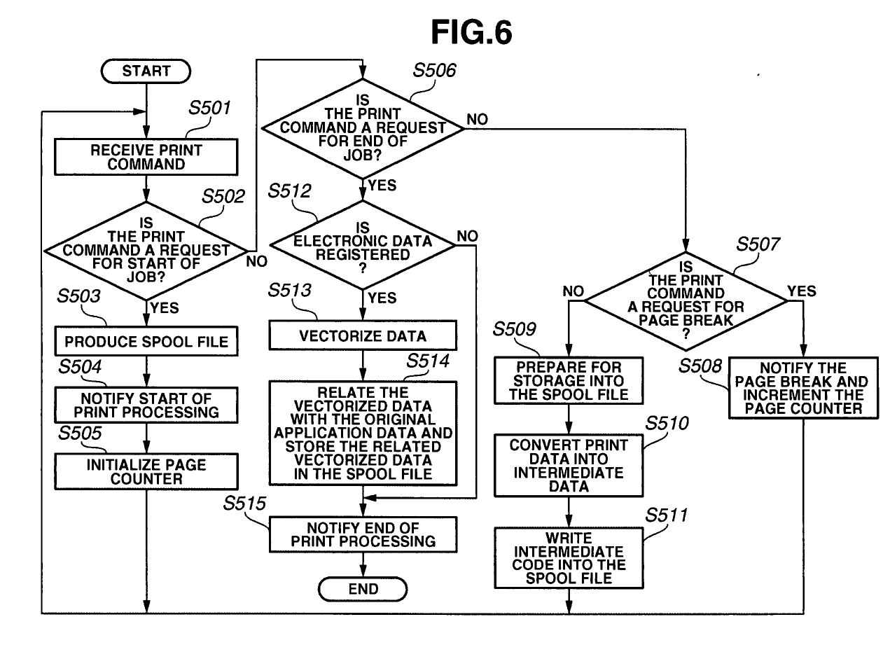

FIG. 5 is a schematic diagram showing one example of a user interface (dialog) for performing settings for printing and registration. The application 301, when the instruction for printing is issued from a user, activates the printer driver 303. The printer driver 303 displays a dialog for inputting the settings for printing and registration as shown in FIG. 6 on a monitor of the client PC 102, and thus, the content of the settings for printing and registration inputted by the user by using the dialog is sent to the spooler 402 from the printer driver 303.

In FIG. 5, when the user selects an RCP (rich content print) tag of tags 602, a preview image of a print image is displayed in an area 601. Note that the RCP refers to an operation for printing the electronic data and an operation for registering the electronic data of the original or the application data that can reuse the original data (for example, the data obtained by vectorizing the electronic data of the original) to the server. A radio button 603 is a button for performing a setting as to whether the RCP is performed or not. In addition, a button 605 is a button for performing a more detailed setting in registering the electronic data. Note that the details of registration of the electronic data of the original will be described later below.

(Exemplary Processing of the Spooler)

FIG. 6 is a flow chart showing an example of a processing performed by the spooler 402. The spooler 402, upon receipt of the print command from the dispatcher 401 (step S501), determines whether the received print command is a request for start of a job (step S502). If it is determined that the received print command is a request for start of a job, the spooler 402 produces the spool file 403 for temporarily storing the intermediate data (step S503), then notifies the start of print processing to the spool file manager 404 (step S504), initializes a page counter allocated to the RAM and the like to “1” (step S505), and then returns the processing to step S501.

On the other hand, if it is determined that the received print command is not a request for start of a job in step S502, the spooler 402 performs a determination as to whether the received print command is a request for end of a job or not (step S506) and also a determination as to whether the received print command is the print command a request for page break (step S507). If it is determined that the received print command is not a request for end of a job and that is the print command a request for page break, the spooler 402 notifies the page break to the spool file manager 404 and increments the page counter (step S508), and then returns the processing to step S501.

If it is determined that the received print command is neither a request for end of a job nor a request for page break, the spooler 402 prepares for the storage of the intermediate code and the data obtained by vectorizing the application data of the original (hereinafter referred to as vectorized data) (step S509), then converts the print data included in the received print command into the intermediate code (step S510), then writes the intermediate code into the spool file 403 (step S511), and after that, returns the processing to step S501. The spooler 402 repeats the processing until the spooler 402 receives the request for end of the job.

On the other hand, if it is determined that the received print command is a request for end of a job, the spooler 402 determines whether the electronic data is set to be registered (step S512). If it is determined that the registration is set (that is, if “Yes” is selected for the radio button 603 as shown in FIG. 5), activates vectorization application, then converts the intermediate code stored in the spool file 403 into the vectorized data (step S513), then relates the vectorized data with the application data of the original, and then stores the vectorized data into the spool file 403 (step S514). After that, the spooler 402 notifies the spool file manager 404 of the end of the print processing (and also, if the registration is set, the registration processing) (step S515), and ends the processing. Note that a method of vectorization and the registration will be described in detail later below.

(Exemplary Processing by the Spool File Manager)

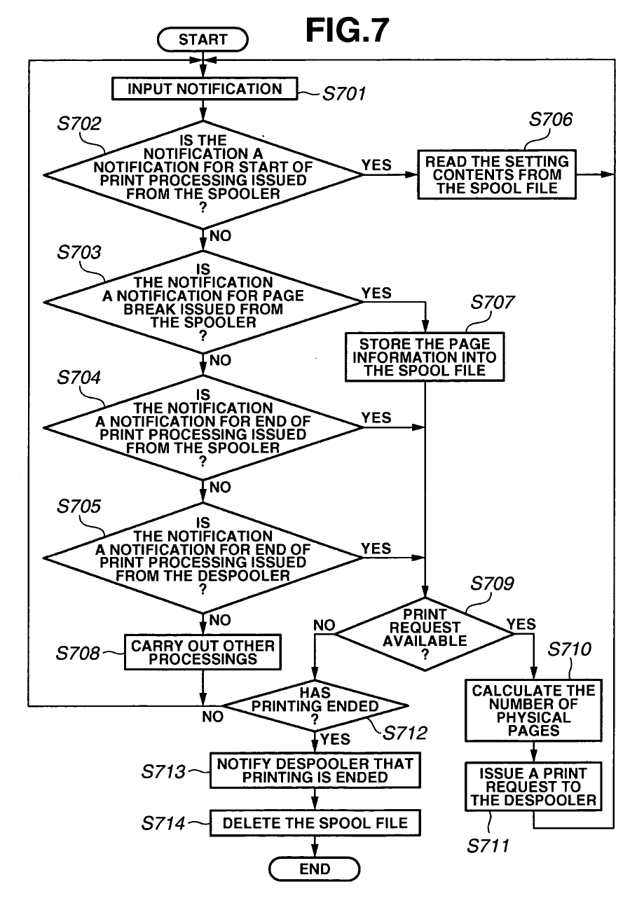

FIG. 7 is a flow chart showing an example of a processing performed by the spool file manager 404. The spool file manager 404, upon receipt of a notification of status from the spooler 402 or the despooler 405 (step S701), performs a determination as to whether the notification is a notification for start of the print processing issued from the spooler 402 in step S504 (step S702), whether the notification is a notification for page break issued from the spooler 402 in step S508 (step S703), whether the notification is a notification for end of the print processing (step S704), and whether the notification is a notification for end of print processing of a physical page issued from the despooler 405 (step S705). In addition, if it is determined that the notification is none of the notifications mentioned above, the spool file manager 404 performs other processings (step S708) and returns the processing to step S701.

If it is determined that the notification is a notification for start of the print processing, the spool file manager 404 reads the content of the setting, starts a job management (step S706), and then returns the processing to step S701.

If it is determined that the notification is a notification of a page break corresponding to the end of the print processing of one logical page, the spool file manager 404 stores page information of the logical page into the spool file 403 (step S707), performs a determination as to whether the print command can be issued to the despooler 405 (step S709) If it is determined that the notification is a notification of the end of the print processing or the printing of the physical page, determines whether the print request can be issued to the despooler 405 (step S709).

In the determination as to whether the print request can be issued (step S709), it is determined whether the printing for one page of the recording paper can be started for N (N is an integer of 1 or greater) logical pages. For example, if a layout such that four logical pages are composed in the physical page, a first physical page can be printed at a time when a fourth logical page is spooled, and a second physical page can be printed at a time an eighth logical page is spooled. Further, there is a limitation on a number of physical pages that can be simultaneously subjected to the print processing by the despooler 405, and thus even if a number of logical pages that can be printed in relation to the number of physical pages are spooled, there is a case where the print request cannot be issued, depending on the state of processing by the despooler 405. That is, in step S708, it is determined whether printing can be requested to the despooler 405.

Note that in this embodiment, a number of physical pages that can be simultaneously subjected to the print processing by the despooler 405 is assumed to be one. In addition, of course, it is determined that the physical page can be printed upon receipt of the notification of the end of the print processing issued by the spooler 402, if the page number of the spooled logical page does not reach a multiple of the number of logical pages to be laid out in the physical page.

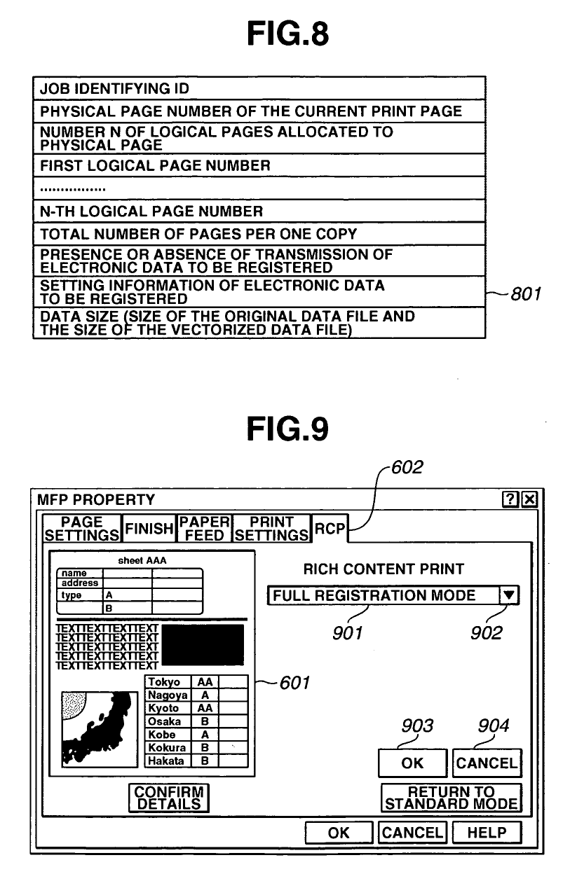

If it is determined that the print request can be issued in step S709, the spool file manager 404 computes the number of physical pages on the basis of the number of logical pages composed onto one single recording paper (step S710), notifies the despooler 405 of the print request including information of the logical page that constitutes the printable physical page of a format as shown in FIG. 8 and also including information of the number of the physical page, and the like (step S711), and then returns the processing to step S701. If it is determined that the print request cannot be issued to the despooler 405, the spool file manager 404 determines whether the printing has ended (in other words, whether a last logical page is printed) (step S712).

If it is determined that the printing has not ended yet, the spool file manager 404 returns the processing to step S701, while if it is determined that the printing has ended, the spool file manager 404 notifies the despooler 405 that the printing has ended (step S713), then deletes the spool file 403 (step S714), and then the processing ends.

Note FIG. 8 is a diagram showing one example of the information that is notified to the despooler 405 from the spool file manager 404. The despooler 405 reads necessary information from the spool file 403, upon request for printing by the spool file manager 404, then produces the print data, and if the RCP is specified, prepares for sending of the data to be registered (the application data of the original and the vectorized data). After that, the despooler 405 sends the print data (if the RCP is specified, the data to be registered, as well) to the MFP 100. The MFP 100 prints the document in accordance with the received print data, and if the despooler 405 receives the data to be registered, registers the data to be registered to the database server 105. Note that the data to be registered can be-registered by sending the data directly from the client PC 102 to the database server 105.

In this regard, although the name and a functional framework are different with respect to the OS that is used, the module may be any module that can implement the technical elements, and thus the difference in the name and the functional framework does not substantially matter. For example, the spooler and the spool file can be implemented by including an appropriate processing in the module that is called a print queue, depending on the kind of the OS. Note that commonly, a host computer that executes each functional module is constituted by hardware such as a CPU, a ROM, a RAM, a hard disk drive (HDD), various kinds of input/output (I/O) control units, and the software called the OS (basic software) controls over each hardware, and further, each application software program and a subsystem process operates as the functional module on the OS.

[Exemplary Registration Settings]

If the RCP is not set (if “No” of the radio button 603 is selected) in the print setting dialog as shown in FIG. 5, a routine print processing is carried out, and the print data that is outputted by the application 301 by the above processing is printed by the MFP 100. In addition, if the RCP is set (if “Yes” of the radio button 603 is selected), the electronic data of the original that is produced (or opened) by the application 301 is subjected to a vectorization processing (to be described later), in addition to the routine print processing. Thus, the vectorized data that is processed to be of a format reusable object by object in relation to a plurality of domains is registered in the database server 105. Note that the vectorized data can be utilized as index information for retrieval of the electronic data of the original.

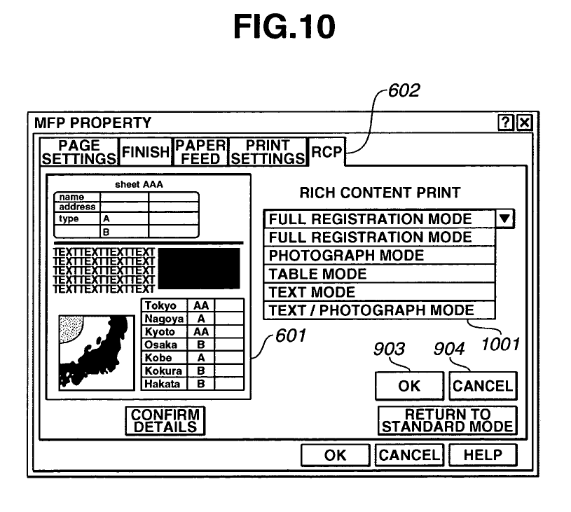

If the RCP is set in the print setting dialog as shown in FIG. 5, a “Detailed Settings” key 605 is activated, and further, the settings with respect to the vectorization can be changed. In this regard, FIG. 9 and FIG. 10 are diagrams respectively showing one example of a print setting dialog that is displayed when the “Detailed Settings” key 605 is pressed.

In a box 901, a default registration method or a method of registration that is currently set is displayed. When the user presses a pull down arrow 902, as shown in FIG. 10, the content that can be set as the registration method is displayed in a pull down menu 1001. In addition, when an “OK” key 903 is pressed, the registration method displayed in the box 901 is finally specified. If the user presses a “Cancel” key 904, the change applied to the registration method is cancelled, and the screen returns to the display as shown in FIG. 5, with the registration method that is currently set being effective.

There are five kinds of modes for the mode that can be set as the registration method. Namely, for example, there are a “Full Registration Mode”, a “Photograph Mode”, a “Table Mode”, a “Text Mode”, and a “Text/Photograph Mode”. When the Text Mode is selected, for example, the “Text Mode” is displayed in the box 901, and if the “OK” key 903 is pressed in this state, the text mode is set to be included in the content of the setting of the RCP, and then the “Text Mode” is recorded in setting information 801 of the electronic data to be registered as shown in FIG. 8. A function of each setting mode is as described below.

(Full Registration Mode)

The original electronic data is vectorized and all the information is sent to the database as the registration information.

(Photograph Mode)

A photographic object (an object rasterized to be a bitmap image) among the vectorized data is sent to the database as the registration information. Other objects are recognized as NULL (null information), and positional information thereof is sent to the database.

(Text Mode)

A text object, among the vectorized data, is sent to the database as the registration information. Other objects are recognized as NULL, and positional information thereof is sent to the database.

(Text/Photograph Mode)

A text object and a photographic object (an object rasterized to be a bitmap image) among the vectorized data are sent to the database as the registration information. Other objects are recognized as NULL, and positional information thereof is sent to the database.

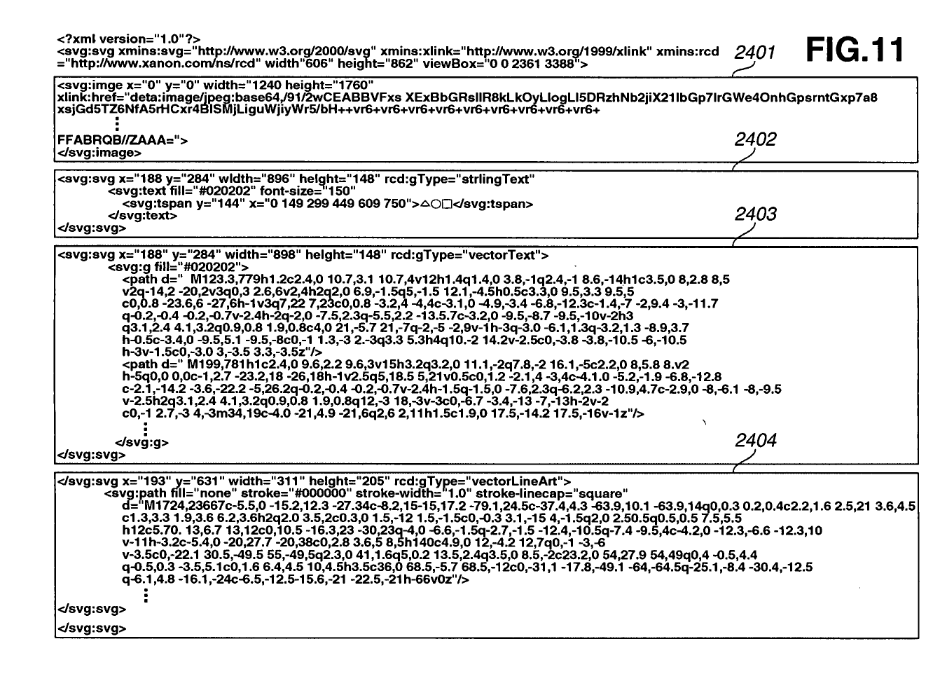

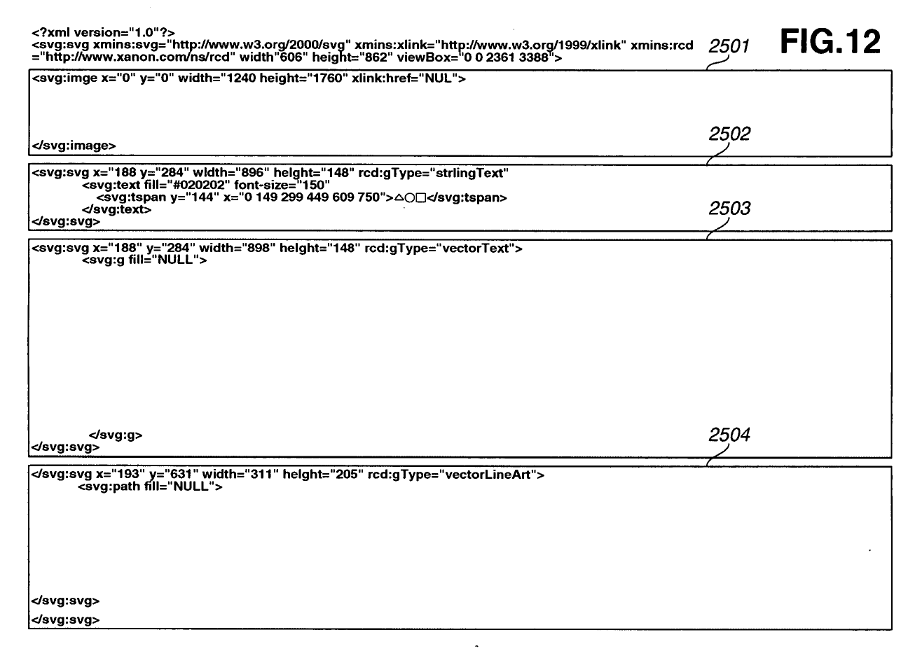

FIG. 11 and FIG. 12 are diagrams respectively showing one example of vectorized data when a full registration mode is set. Note that in each of FIG. 11 and FIG. 12, an example in which the vectorized data is described in a scalable vector graphics (SVG) format is shown, however, the configuration is not limited to this. Further, in FIG. 11, descriptions of the objects are framed for explanation.

The descriptions as framed by a frame 2401 indicate an image attribute. The descriptions in the frame 2401 include area information that indicates an area of an image object and bitmap information. The descriptions framed in a frame 2402 indicate text attributes, and the descriptions framed in a frame 2403 represent the content of the descriptions in the frame 2402 as vector objects. The descriptions as framed in a frame 2404 indicate attributes of drawings such as a table object and the like.

When the text mode is selected, the objects framed in the frame 2402 among the vectorized data as shown in FIG. 11 only remain present as shown within a frame 2502. With respect to other objects framed in each of the frame 2401, the frame 2403, and the frame 2404, positional information of the objects only remains to be present as shown within each frame 2501, 2503, and 2504 in FIG. 12, and the content is set to be NULL. Thus, the amount of data is suppressed, and an amount of information that the database server 105 stores can be appropriately reduced, and further, an amount of communication in sending and receiving the data between different domains can also be appropriately reduced. In addition, when the photograph mode or the text/photograph mode is selected, the amount of data can be suppressed in the same way, and the data is processed to be the vectorized data, and the vectorized data is registered in the database server 105, as well as the application data of the original.

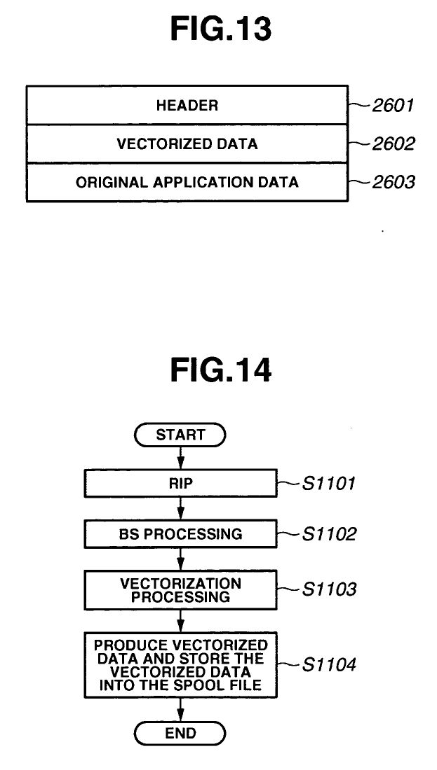

FIG. 13 is a diagram showing a file format obtained by combining the vectorized data and application data of the original. The aforementioned file format as shown is constituted by a header 2601, a vectorized data unit 2602 to which vectorized data is included, and an application data unit 2603 to which the application data of the original is included. The header 2601 describes information conforming to the data format of the data to be registered to the database server 105. That is, the header 2601 describes information such as a size of the vectorized data, a size of the application data of the original, and the content of the RCP settings.

The aforementioned explanation has been made as to the five modes as described above. However, it is noted that this embodiment and present invention is not limited to the five modes. For example, a new mode prepared by combining various kinds of object information can be set.

[Exemplary Vectorization]

FIG. 14 is a flow chart showing the vectorization processing (step S513) performed by the spooler 402 as shown in FIG. 6, in detail. The spooler 402 utilizes core application of a raster image processing (RIP) and thus first converts the intermediate code stored in the spool file 403 into raster data (step S1101). The processing is the same as the processing in which the intermediate data is subjected to rendering in the MFP 100. The raster data is stored in the RAM or the hard disk of the client PC 102, as the image data of each single page.

Next, the spooler 402 carries out a block selection (BS) processing (step S1102), and thus divides the image data stored in the RAM or the hard disk into a text/drawing area that includes the text or the drawing, a halftone photograph area, an area for indefinite-shape image, and other areas. Further, with respect to the text/drawing area, the spooler 402 divides the area into a text area that mainly includes the text and a drawing area that mainly includes a table, graphic, and the like, and further, divides the drawing area into a table area and a graphic area. Note that in this embodiment, the division into each area in accordance with an attribute thereof by detecting a concatenation pixel and by using the shape, size, the pixel density, and the like of a circumscribed rectangle area of the concatenation pixel. However, other methods for dividing the areas may be utilized.

The text area is segmented into a rectangular block (text area rectangular block) in a manner such that a cluster such as a paragraph is used as a block. The drawing area is segmented into a rectangular block per each individual object such as the table, the graphic (a table area rectangular block and a drawing area rectangular block). In addition, the photographic area represented in halftone is segmented into a rectangular block such as an image area rectangular block, a background area rectangular block. Note that the information of the rectangular blocks is referred to as “area division information”.

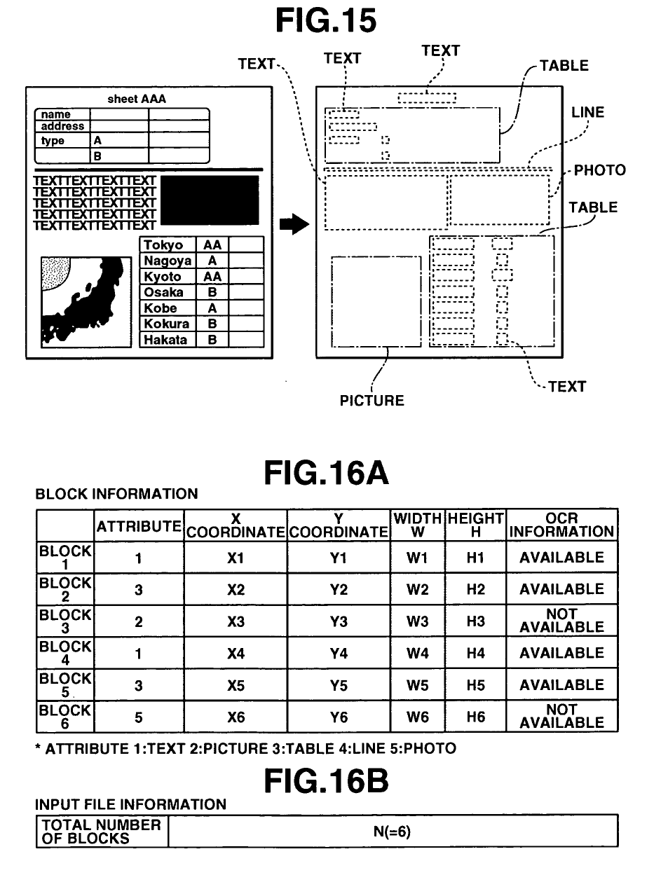

The spooler 402 combines and synthesizes the area division information obtained by the BS processing and the input image, and displays the resultant image on an operation screen of the monitor of the client PC 102, as shown in FIG. 15 as an example. In the operation screen in a left portion thereof, the input image itself is displayed, and in a right portion thereof, the area division information is displayed as the resultant block. Note that in FIG. 15, for a simple understanding of the resultant block, each character string of “TEXT”, “PICTURE”, “LINE”, “TABLE”, and the like that indicates the attribute of the rectangular block is shown, however, the attribute information is not actually displayed in the operation screen, and instead, the rectangular block is displayed as a frame. The attribute information “TEXT” represents a text attribute, the “PICTURE” represents the graphic attribute, the “PHOTO” represents the photograph attribute, the “LINE” represents the drawing attribute, and the “TABLE” represents the table attribute. Of course, a various kinds of display form can be applied other than displaying the input image and the area division information in parallel left and right as shown in FIG. 15. For example, the rectangular block can be displayed on the input image by overlapping the input image with the area division information. In addition, if attributes other than the above attributes are defined, the division of a more kinds of rectangular areas can be made.

Referring back to FIG. 14, next, the spooler 402 converts the image data into the vector data by the vectorization processing (step S1103). The method of vectorization is explained in detail later below. Then, the spooler 402, using the vector data obtained by the vectorization processing, produces the data of a reusable application data format (vectorized data), and stores the resultant vectorized data into the spool file 403 (step S1104).

In a common case, the data format depends on the application to be used. Thus, the data needs to be converted into a file format in accordance with the purpose of use of the data. For example, with respect to word processor software, spreadsheet software, and the like, which are representative application software, the file format in accordance with the purpose of use is defined, and the data file needs to be produced and stored in the defined file format.

For a more general-purpose file format, there is, for example, a rich text format (RTF) defined by MICROSOFT (registered trademark) Corporation. Also, there is a scalable vector graphics (SVG) that is proposed by World Wide Web Consortium (W3C), and in addition, there is a plain text format that simply handles text data. These data formats are likely to be usable in common to the application software.

The vectorized data is produced as the data that can readily by reused (edited or the like) by the above processing. The produced vectorized data is managed together with the application data of the original and stored in the spool file 403.

Now, exemplary processing of primary steps as shown in FIG. 11 is described in detail below.

[Exemplary Block Selection (step S1102)]

The block selection is a processing in which the image of one single page as shown in FIG. 15 is recognized as an aggregate of objects and the attribute of each object is categorized as the text (TEXT), graphic (PICTURE), photograph (PHOTO), drawing (LINE), and table (TABLE) to divide the same into segments (blocks) with mutually different attributes. Next, the block selection is explained by referring to a specific example.

First, the image to be processed is binarized to a monochromatic image, and a cluster of pixels surrounded by black pixels is extracted by contour tracing. With respect to a cluster of black pixels of an area larger than a predetermined area, the contour tracing is carried out for white pixels existing therein to extract a cluster of white pixels. Further, a cluster of black pixels existing within the white pixel cluster of an area larger than a predetermined area is extracted. Thus, the extraction of the cluster of black pixels and the white pixels is recursively repeated.

Then, a rectangular block circumscribing the pixel cluster thus obtained is produced, and the attribute thereof is determined based on the dimension and the shape of the rectangular block. For example, in a case where the pixel cluster of a horizontal to vertical ratio close to 1 and of the dimension of a predetermined range of dimension is determined as the pixel cluster of the character attribute and further, if the pixel clusters of adjacent character attributes are arranged in an appropriate order and if a grouping of the pixel clusters is available, the area including the character attribute is determined as the character area. In addition, the flat pixel cluster with a smaller horizontal to vertical ratio is discriminated to be the drawing area. The portion occupied by the black pixel clusters of a dimension larger than the predetermined dimension and having a shape similar to a rectangle and including appropriately arranged white pixel clusters therein is discriminated to be the table area. The area in which indefinite-shape pixel clusters exist in a scattered manner is discriminated as the photograph area, and the area including other arbitrarily-shaped pixel clusters exist is discriminated as the graphic area.

FIG. 16A and FIG. 16B are exemplary diagrams that respectively show one example of a result of the block selection processing. In FIG. 16A, the block information of each extracted rectangular block is shown. The block information includes the attribute of each block, X and Y coordinates as positional information, an width W, a height H, OCR information, and the like. The attribute is given with numerical values from 1 through 5. The numerical value “1” represents the character attribute, “2” represents the graphic attribute, “3” represents the table attribute, “4” represents the drawing attribute, and “5” represents the photograph attribute, respectively. In addition, the X and Y coordinates represents the X and Y coordinates of an initial point (namely, the coordinates of an upper left corner thereof) of each rectangular block of the input image, the width W and the height H represent the width of the rectangular block in the direction of the X coordinate and the height in the direction of the Y coordinate, respectively, and the OCR information represents the presence or absence of pointer information.

In addition, in FIG. 16B, input file information that indicates a total number of rectangular blocks extracted by the block selection is shown. The block information per each rectangular block is utilized for vectorization with respect to a specified area. In addition, the block information enables a determination and identification of a relative positional relationship between the vectorized specified area and the raster data. Thus, a combination and synthesis of the vectorized area and the raster data area can be carried out without impairing the layout of the input image.

[Exemplary Vectorization Processing (Step S1103)]

There are various methods for the vectorization method, which will now be described below:

(a) For the character attribute area, the character image is converted into character codes by the OCR processing, or is converted into visually true font data by recognizing the size, style, and face of the characters.

(b) For the drawing attribute area or the character attribute area, and if the character recognition by the OCR recognition is not available, the contour of the drawing or the character is traced, and the format thereof is converted into a format in which contour information (outline) is represented as a joint or a connection of line segments.

(c) For the graphic attribute area, contour of the graphic object is traced, and the format thereof is converted into a format in which contour information is represented as a joint or a connection of line segments.

(d) Outline information of a line segment format obtained by the method as described in (b) or (c) above is subjected to fitting processing with using Bezier curve function to convert the outline information into functional information.

(e) The shape of the graphic is recognized by the contour information of the graphic object obtained by the method as described in (c) above, and then the recognized shape is converted into graphic definition information such as a circle, rectangle, and polygon.

(f) For the table attribute area, the straight lines and the frame lines are recognized, and the recognized lines are converted into document format information of a predetermined format.

In addition to the methods as described above, there are various kinds of vectorization processing methods in which the image data is converted into command definition format information such as code information, graphic information, functional information.

[Vectorization of the Character Area]

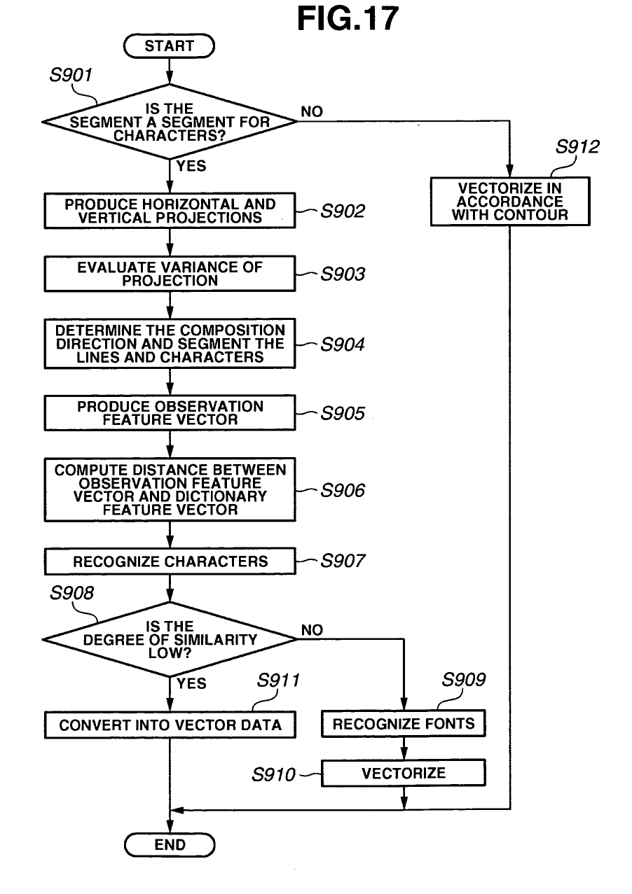

FIG. 17 is a flow chart showing the vectorization processing (step S1103) in detail. First, it is determined whether the segment is a segment for characters with reference to the block information (step S901). If it is determined that the segment is the segment for the character attribute, the processing advances to step S902. In step S902, the character recognition is carried out by using one method of pattern matching to obtain corresponding character codes.

In addition, for the segment other than the character attribute, the vectorization based on the contour of the image is carried out (step S912). The detail thereof is described later below.

In addition, in the case of the segment of the character attribute, in order to determine whether the characters are described horizontally or vertically (that is, in order to perform a determination as to a composition direction), horizontal and vertical projections are produced in relation to a pixel value (step S902), variance of the projection is evaluated (step S903). Further, in step S904, if the variance in the horizontal projection is large, it is determined that the characters are horizontally composed, and on the other hand, if the variance in the vertical projection is large, it is determined that the characters are vertically composed. In accordance with the result of determination, the lines are segmented, and after that, the characters are segmented, and thus a character image is obtained.

In the case of horizontal composition, with respect to decomposition into character strings and into characters, the lines are segmented by using the horizontal projection and the characters are segmented from the projection perpendicular to the segmented lines. With respect to the character area of the vertical composition, a processing that is reverse in relation to the above-described processing in the horizontal and the vertical directions is applied. Note that in segmenting the lines and the characters, the character size can be determined.

Next, with respect to each segmented character, an observation feature vector, which is obtained by converting a feature obtained from a character image into several tens-dimensional numerical series, is produced (step S905). There are various kinds of publicly known method of extracting a feature vector. In this regard, there is a method in which the character is segmented in a mesh-like shape and a mesh-number dimensional vector obtained by counting character lines in each mesh portion as line elements in each direction is determined to be the feature vector.

Next, a distance between the obtained observation feature vector and a dictionary feature vector is computed by comparing the obtained feature vector and the dictionary feature vector (step S906). Note that the dictionary feature vector mentioned here is previously computed per each character type. Then, the computed distance is evaluated, and the character type with a shortest distance is determined to be a result of recognition (step S907). Further, a shortest value and the threshold value are compared to each other based on the result of distance evaluation, and if the shortest distance is less than the threshold value, it is determined that the degree of similarity is high, and on the other hand, if the shortest distance is equal to or more than the threshold value, it is determined that the degree of similarity is low (step S908). In the case where the shortest distance is equal to or more than the threshold value (if the degree of similarity is low), it is highly likely that the character is wrongly recognized as other character with a similar shape, and therefore, the result of recognition by step S907 is not used and the character image is treated in the same manner as in the case of the drawing, and thus the outline of the character image is vectorized (step S911). In other words, with respect to the character image that is likely to be recognized as a similar wrong different character, the visually true outline vector data is produced.

On the other hand, if the similarity degree is high, the result of recognition by step S907 is used, and as well, a plurality of the dictionary feature vectors corresponding to a number of character types used for character recognition is prepared in relation to a character shape type (font type), and thus the character font is recognized by outputting the font type together with the character code in performing the pattern matching (step S909). Sequentially, the character code and the font information obtained by character recognition and the font recognition are referred to, and then each character is converted into vector data by using previously prepared outline data corresponding to each of the character code and the font information (step S910). Note that in the case of a color image data, a color of the character is extracted and recorded together with the vector data.

The above processing enables the conversion of the character image included in the character attribute segment into the vector data that is true with respect to the shape, size, and color.

[Exemplary Vectorization of the Area Other Than the Character Area (step S912)]

With respect to the segments other than the character attribute segment, namely, the segments that are determined to be the graphic attribute, drawing attribute, or the table attribute, a black pixel cluster is extracted, and the contour of the extracted black pixel is converted into the vector data. Note for the photograph attribute segment, the image data is used as it is, without being vectorized.

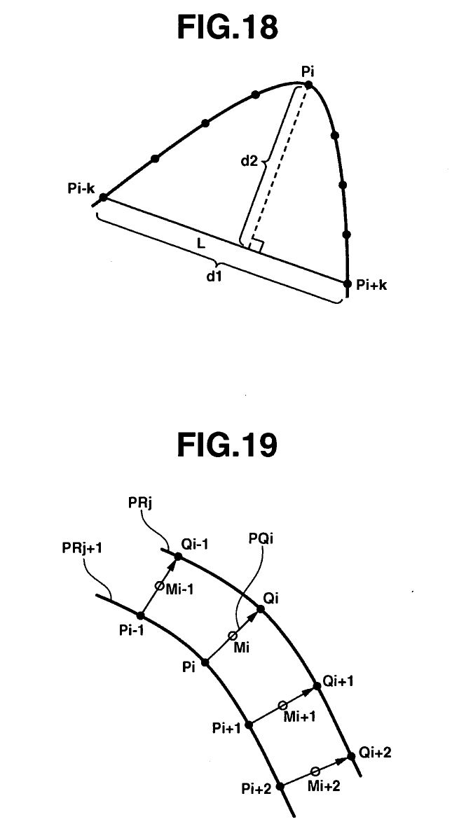

With respect to the vectorization of the areas other than the character area, first, in order to represent the drawing and the like as a combination of straight lines and/or curved lines, a “vertex” that segments the curved lines into a plurality of sections (pixel rows) is extracted. FIG. 18 is a diagram that explains an exemplary vertex extraction processing performed in the course of the vectorization. The vertex is a point at which the curvature becomes maximum, and a determination as to whether a pixel Pi on the curved line as shown in FIG. 18 is carried out in a manner as described below.

First, the pixel Pi is defined as an initial point, and then, a pixel (Pi−k) is connected with a pixel (Pi+k), each of which being distant from the pixel Pi by a distance equivalent to a predetermined pixel number k along the drawing curved line, by using a line segment L. Then, let the distance between the pixel (Pi−k) and the pixel (Pi+k) be d1, a length of a straight line segment taken from the pixel Pi to be perpendicular to the line segment L (namely, the distance between the pixel Pi and the line segment L) be d2, and if d2 becomes maximum in this case, the pixel Pi is determined to be a vertex. Otherwise, let a length of an arc between the pixel (Pi−k) and the pixel (Pi+k) be A and if a ratio of A to the distance d1, namely, d1/A is or less than a predetermined threshold value, the pixel Pi is determined to be a vertex.

After extraction of the vertexes, the pixel rows of the drawing curved lines divided by the vertexes is approximated into a straight line or a curved line. The approximation to the straight line is performed by a least squares method or the like, and for the approximation to the curved line, a cubic spline function or the like is used. The pixel of the vertex that divides the pixel rows is an initial point or a terminal point in the approximation straight line or the approximation curved line.

Further, a determination is made as to whether an inner contour of the white pixel cluster is present in the vectorized contour. If it is determined that the inner contour is present, the contour is vectorized. Then, the processing is applied to an inner contour of the inner contour and beyond, and thus the inner contours of the black pixel cluster and the white pixel cluster are recursively vectorized.

As described above, the method of approximating the separatrixes of the contours with the straight line or the curved line enables vectorization of the outline of the graphic of an arbitrary shape. In addition, if the input image is a color image, a color of the graphic is extracted from the color image, and the extracted color of the graphic is recorded together with the vector data.

FIG. 19 is a diagram that explains an exemplary processing for linking contours performed in the course of the vectorization. If an outer contour PRj and an inner contour (PRj+1) (or other outer contour) are adjacent to each other in a noticed section of the contour line, the adjacent contour lines are linked to each other and the adjacent contour lines can thus be represented as one line with a thickness. In this regard, for example, it is executed the following step of: (1) calculating each of distances PQn (n=i−1, i, i+1, i+2, and so on) between a pixel Pn on the contour (PRj+1) and a pixel Qn on the contour PRj that is closest to the pixel Pn; (2) if the variance of the distances PQn (n=i−1, i, i+1, i+2, and so on) is very small, approximating the contours PRj and (PRj+1) with a straight line or a curved line that goes along dot rows of middle points Mn of the line segments PQn, with respect to the noticed sections (n=i−1, i, i+1, i+2, and so on); (3) determining the thickness of the approximation straight line or the approximation curved line, for example, an average value of the distances PQn (n=i−1, i, i+1, i+2, and so on).

A chart ruled line, which is a line or an aggregate of lines can be effectively represented as a vector by representing the chart ruled line as an aggregate of lines with a thickness.

[Exemplary Recognition of the Graphic]

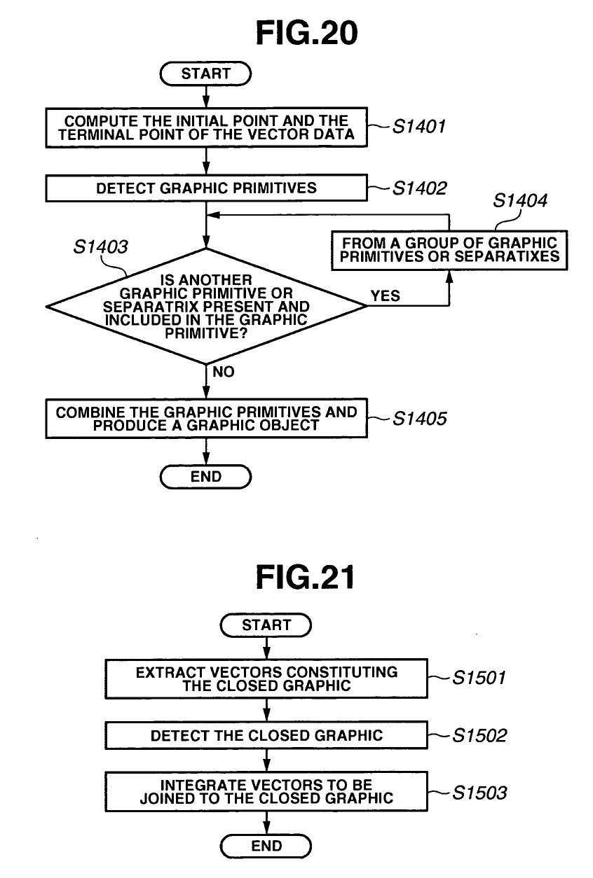

After the outlines of the line graphics and the like are vectorized by the above processing, the vectorized separatrixes are grouped per graphic object. FIG. 20 is a flow chart showing an exemplary processing for grouping vector data produced by the vectorization. In FIG. 20, the processing for grouping the vector data per graphic object is shown.

First, an initial point and a terminal point of each vector data are computed (step S1401). Then, by using information of the initial point and the terminal point, graphic primitives are extracted (step S1402). The graphic primitive is a closed graphic constituted by separatrixes. In extracting the graphic primitive, the vectors are linked to each other at the pixel of a vertex common to the initial and the terminal points. That is, a principle is applied that each group of vectors constituting the closed shape has a vector for linking at both ends thereof.

Next, a determination is made as to whether another graphic primitive or separatrix is present and included in the graphic primitive (step S1403). If it is determined that another graphic primitive or separatrix is present and included in the graphic primitive, steps S1401 and S1402 are recursively repeated, and one single graphic object is produced by grouping the resultant of the processing by steps S1401 and S1402 (step S1404). If it is determined that another graphic primitive or separatrix is not present and included in the graphic primitive, the graphic primitive is extracted as the graphic object (step S1405).

Note that in FIG. 20, the processing for one single graphic object only is shown, however, if there are present another graphic objects, the processing as shown in FIG. 20 is repeated for another graphic objects.

(Exemplary Extraction of the Graphic Primitive (Step S1402))

FIG. 21 is a flow chart showing exemplary processing for extracting the graphic primitive. First, the vectors that do not have a vector for linking at both ends thereof are eliminated from the vector data, and the vectors that constitute the closed graphic are extracted (step S1501). Next, with respect to the vectors that constitute the closed graphic, vectors are sequentially searched for in a specific direction (for example, clockwise), with either one of ends of the vector (namely, the initial point or the terminal point) being a starting point. That is, the end points of other vectors are searched for at other end of the vector constituting the closed graphic, and then, a nearest end point present within a predetermined distance is defined as an end point of the linking vector.

When the search for the vector returns to the starting point after all the vectors constituting the closed graphic are once searched for, all the vectors that has been searched for are grouped as one single closed graphic that constitutes one single graphic primitive (step S1502). In addition, vectors that constitute another closed graphic existing inside the closed graphic are recursively grouped altogether. Further, the above processing is repeated with an initial point of vectors that are not grouped yet as a starting point.

Then, the vectors whose ends are adjacent to the vectors grouped as the closed graphic among the eliminated vectors (namely, the vectors linked to the closed graphic) are extracted, and then the extracted vectors are grouped into the group of the vectors grouped as the closed graphic (step S1503).

The above processing enables handling of the graphic block as a reusable individual graphic object.

[Conversion into the Application Data Format (Step S1104)]

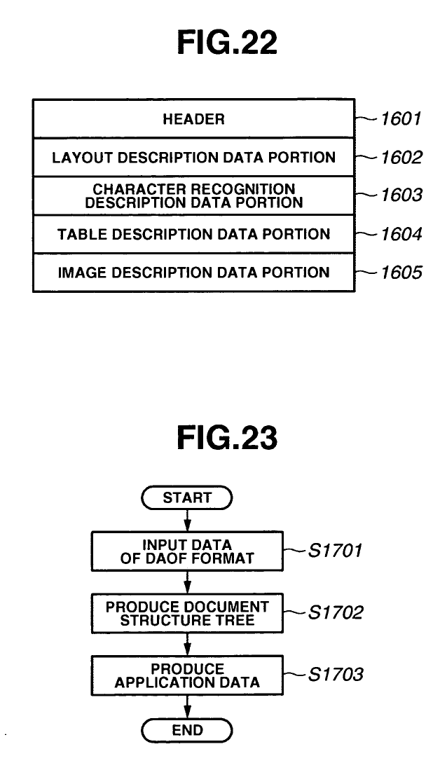

FIG. 22 is a diagram showing a format of the intermediate data that indicates a result of the vectorization processing. Hereinbelow, a storage format of the intermediate data is referred to as a “document analysis output format (DAOF)”. The DAOF is constituted by a header 1601, a layout description data portion 1602, a character recognition description data portion 1603, a table description data portion 1604, and an image description data portion 1605. The header 1601 includes therein information related to the input image to be processed.

The layout description data portion 1602 includes therein information such as TEXT (character), TITLE, CAPTION, LINE (drawing), PICTURE (drawing), FRAME, TABLE, and PHOTO, each of which indicates attribute of a rectangular segment within the rectangular segment, and also includes therein positional information of each such rectangular segment.

The character recognition description data portion 1603 includes therein a result of the character recognition obtained by the character recognition of an area specified by the user among the rectangular segments of the character attribute such as TEXT, TITLE, and CAPTION.

The table description data portion 1604 includes therein details of a table structure of the rectangular segment of the table attribute. The image description data portion 1605 includes therein the image data segmented from the input image data of the rectangular segment of the drawing attribute and the drawing attribute.

In the image description data portion 1605 of a vectorized specific area, an inner structure of the segment obtained by the vectorization processing and an aggregate of data that expresses the shape of the image, the character code, and the like are included. On the other hand, the non-vectorized segments of the area other than the specified area includes the input image data itself.

FIG. 23 is a flow chart showing an exemplary processing for conversion of the data into the data of an application data format. First, the data of the DAOF format is inputted (step S1701), then a document structure tree that is a source of the application data is produced (step S1702), and then the application data is produced by obtaining actual data within the DAOF data on the basis of the document structure tree (step S1703).

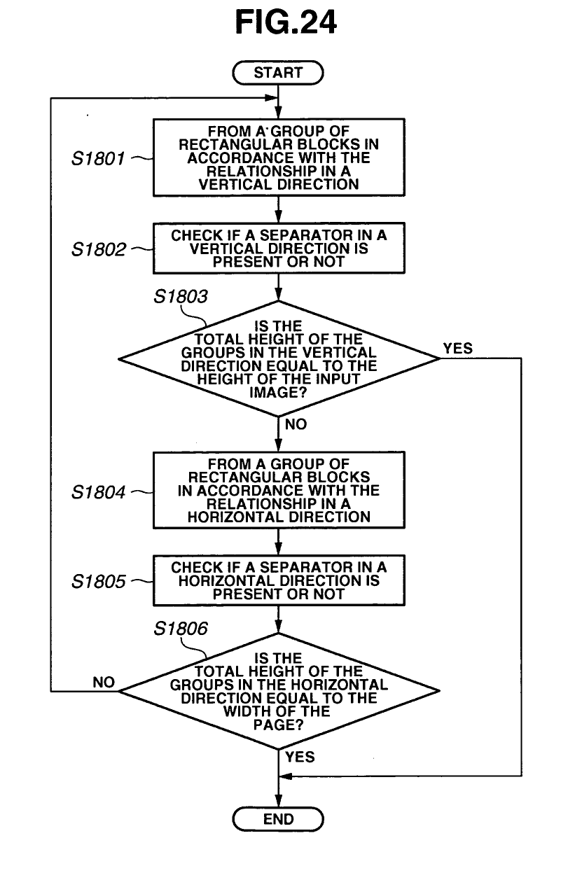

FIG. 24 is a flowchart showing a detail of an exemplary processing for producing the document structure tree (step S1703). Note that the flow of the processing, as a principal rule for an overall control in this processing, shifts from a micro block (a single-rectangular block) to a macro block (an aggregate of the rectangular blocks). Hereafter, the “rectangular block” refers to both the micro block and the macro block.

In this regard, first, the rectangular blocks are grouped in accordance with a relationship between the rectangular blocks in a vertical direction (step S1801). Note that the processing as shown in FIG. 24 may be repeatedly executed, and in that case, the processing executes a determination per one single micro block, immediately after start of the processing. Here, the relationship is defined by a feature such as the distance between the rectangular blocks is short, the widths of the blocks (in the case of using a relationship in a horizontal direction, the heights of the blocks) are substantially the same, and the like. In addition, the information of the distance, width, height, and the like refers to the DAOF.

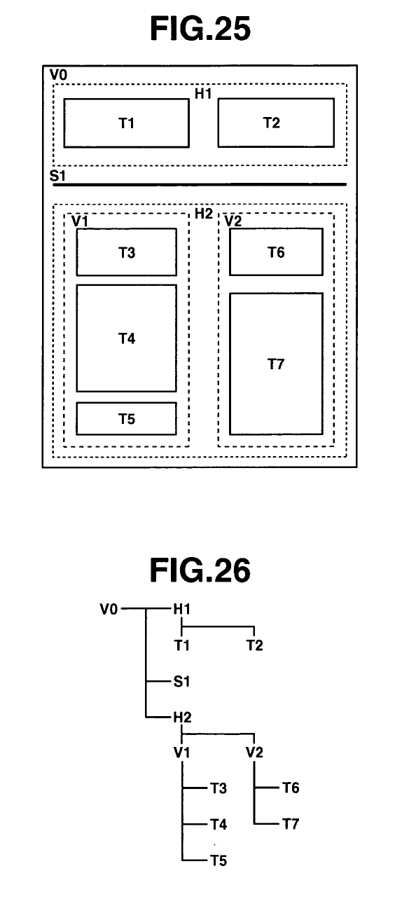

For example, in the case of the input image as shown in FIG. 25, rectangular blocks T1 and T2 are positioned in parallel to each other at an uppermost portion of the input image. A horizontal-direction separator S1 exists below the rectangular blocks T1 and T2, and rectangular blocks T3, T4, T5, T6, and T7 exist below the horizontal-direction separator S1. The rectangular blocks T3, T4, and T5 are disposed in a left-half portion of a lower area of the horizontal-direction separator S1, vertically and downwards. The rectangular blocks T6 and T7 are disposed in a right-half portion of a lower area of the horizontal-direction separator S1, vertically and downwards.

When the grouping in accordance with the vertical relationship is executed in step S1801, the rectangular blocks T3, T4, and T5 are grouped in one single group (a rectangular block V1), and also the rectangular blocks T6 and T7 are grouped in one single group (a rectangular group V2). The groups V1 and V2 are in the same layer.

Next, presence or absence of the separator in the vertical direction is checked (step S1802). The separator is an object that has a drawing attribute within the DAOF, and also functions, in application software, to explicitly divide the blocks. When the separator is detected, in the layer to be processed, the area of the input image is divided into two left and right, with the separator being a border thereof. In an example as shown in FIG. 25, there is provided no vertical-direction separator.

Next, a determination is made as to whether a total sum of the heights of the groups in the vertical direction is equal to the height of the input image (step S1803). That is, it is determined that the processing has ended by utilizing a result of the horizontal-direction grouping such that the total sum of the heights of the groups is equal to the height of the input image when the whole part of the input image ends.

If the grouping has not ended yet, the rectangular blocks are grouped in accordance with a horizontal-direction relationship (step S1804). Thus, the rectangular blocks T1 and T2 are grouped in one single group (a rectangular block H1) and the rectangular blocks V1 and V2 are grouped in one single group (a rectangular block H2). Here, the groups H1 and H2 are in the same layer. Here, just as described above, the processing executes a determination per one single micro block.

Next, presence or absence of the separator in the horizontal direction is checked (step S1805). When the separator is detected, in the layer to be processed, the area of the input image is divided into two up and down, with the separator being a border thereof. In an example as shown in FIG. 25, there is provided a horizontal-direction separator S1.

Next, a determination is made as to whether a total sum of the widths of the groups in the horizontal direction is equal to the width of the input image (step S1806). That is, if it is determined that a total sum of the widths of the groups in the horizontal direction is equal to the width of the input image, it is determined that the processing of horizontal-direction grouping has ended. In other words, the processing for producing the document structure tree ends when the total sum of the widths of the horizontal-direction group is equal to the width of the input image (page width). If it is determined that the total sum of the widths of the horizontal-direction groups is below the page width, the processing returns to step S1801, and then the processing repeats the check on the relationship in the vertical direction in a layer one stage above the layer.

FIG. 26 is a diagram showing the document structure tree obtained by an image V0 as shown in FIG. 25. The image V0 includes the groups H1 and H2 and the separator S1 in its uppermost layer. In the group H1, the rectangular blocks T1 and T2 are included, which are in a second layer. In addition, in the group H2, second layer groups V1 and V2 are included. In the group V1, third layer rectangular blocks T3, T4, and T5 are included. In the group V2, third layer rectangular blocks T6 and T7 are included.

When the processing comes to the tree as shown in FIG. 26, the total sum of the width of the horizontal groups is equal to the page width, and accordingly, the processing ends, and finally, the image V0, which represents the whole part of the page, is added to the document tree structure. Then, after the document structure tree is finally produced, the application data is produced in accordance with the information thereof.

In this regard, first, the group H1 includes two regard blocks T1 and T2 in the horizontal direction. That is, the group H1 includes two columns. Then, the DAOF of the rectangular block T1 is referred to, and information internal thereof (sentences obtained as a result of the character recognition, the image, and the like) is outputted to a first column (a left column). After that, the processing shifts to the step taken to a second column (a right column), and internal information of the rectangular block T2 is output, and after that, the separator S1 is output.

Then, the processing shifts to the step with respect to the group H2. The group H2 includes two rectangular blocks V1 and V2 in the horizontal direction. That is, the group H2 includes two columns. Then, in an order of the rectangular blocks T3, T4, T5 of the group V1, the internal information thereof is outputted to a first column (a left column). Then, the processing shifts to the step taken to a second column (a right column), and in an order of the rectangular blocks T6 and T7 of the group V2, the internal information thereof is output. Thus, the processing of conversion into vectorized data of the application data format is executed by the above processing.

As described above, in the image processing system that retrieves the electronic data of the original from the document information of the print document or that reuses the electronic data, a selective registration of the electronic data can be performed by an apparatus to which the electronic data is registered, in accordance with the kind and type of the object. That is, in such an image processing system, the object to be registered can be controlled. For example, a selective control can be performed in which the objects that a producing person (or a registrant) of the document desires to reusably save or store, by registering all objects or by registering the photographic object, the table object, the character object or the character/photographic object are registered and the other objects are registered in relation only to the positional information thereof. Accordingly, an increase in the amount of data to be registered, which occurs in the above image processing system, can thus be prevented.

In addition, in other words, by registering to the image processing system the attribute of the object to be registered, instead of registering the data itself, the object of an unnecessary attribute can be excluded from the objects to be registered to the image processing system, so that the objects desired to be registered only are registered. Thus, data amount of the electronic data to be registered can be appropriately decreased.

### Second Exemplary Embodiment

Hereinbelow, the image processing according to a second embodiment of the present invention is explained. Note that in the second embodiment, with respect to configurations thereof that are similar to those in the first embodiments, the same reference numerals and symbols are provided thereto and a detailed explanation thereof is omitted.

In the first embodiment, an explanation is made as to an example in which the registration data (the application data of the original and the vectorized data) is registered to the database server 105 in a case where the RCP is set in the user interface (print/registration setting dialog) that the printer driver 303 provides. In the second embodiment, in order to further decrease the amount of the data to be registered to the database server 105, the data to be registered is limited to the vectorized data.

In the second embodiment, the despooler 405 reads necessary information from the spool file 403 upon request for printing issued from the spool file manager 404, produces print data, prepares for transmission of the data to be registered (vectorized data) if the RCP is specified, and then transmits the print data (if the RCP is specified, the data to be registered, as well) to the MFP 100. the MFP 100 prints the document, and if the MFP 100 receives the data to be registered, registers the received data to be registered to the database server 105. Note that the data to be registered may be registered by directly transmitting the same from the client PC 102 to the database server 105.

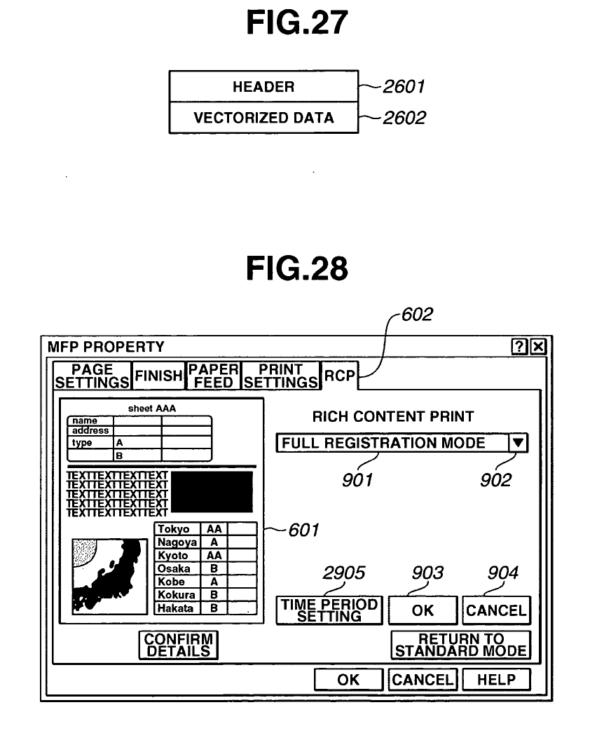

FIG. 27 is a diagram showing a file format of vectorized data according to the second embodiment of the present invention. The file format of the vectorized data is constituted by the header 2601 and the vectorized data unit 2602. The header 2601 includes information conforming to a format of the data to be registered to the database server 105. That is, in the header 2601, information on the size of the vectorized data, the size of the application data of the original, the contents of the setting of RCP and the like are included.

### Third Exemplary Embodiment

Hereinbelow, the image processing according to a third embodiment of the present invention is explained. Note that in the third embodiment, with respect to configurations thereof that are similar those in the first embodiment and the second embodiment, the same reference numerals and symbols are provided thereto and a detailed explanation thereof is omitted.

In the first embodiment, an explanation is made as to an example in which the registration data (the application data of the original and the vectorized data) is registered to the database server 105 in a case where the RCP is set in the user interface (print/registration setting dialog) that the printer driver 303 provides. In the third embodiment, an explanation is made as to a case where a period of registration to the database server 105 of the registration data by using the above user inter face is set, an entity of the registration data whose registration period has elapsed is erased from the database server 105, so as to suppress the registration data amount.

As described above, if the RCP is set in the print setting dialog as shown in FIG. 5, the “Detailed Settings” key 605 is made active, and further, the settings as to vectorization can be changed. FIGS. 28 through 30 are diagrams that respectively show one example of a print setting dialog displayed when a “Detailed Settings” key 605 is pressed, according to a third embodiment of the present invention.

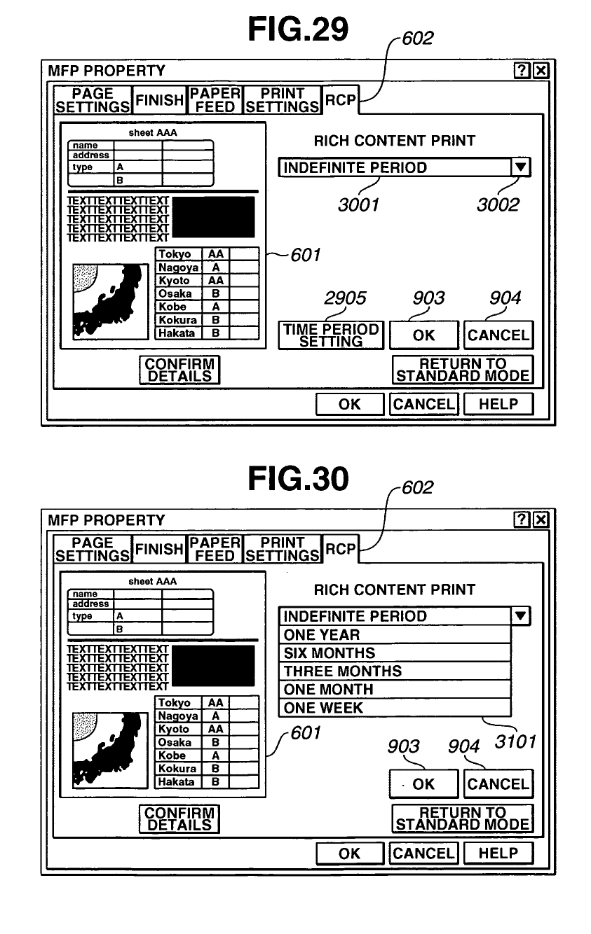

When a “Time Period Setting” key 2905 in the user interface as shown in FIG. 28 is pressed, the user interface as shown in FIG. 29 is displayed, then a default period or the currently-set period is displayed in a box 3001. If a pull down arrow 3002 is pressed, as shown in FIG. 30, the content that can be set as the time period is displayed in a pull down menu 3101.

The time period that can be set includes six different periods such as “Indefinite Period”, “One Year”, “Six Months”, “Three Months”, “One Month”, and “One Week”. In this regard, for example, if the period “One Month” is selected, the selected period “One Month” is displayed in the box 3001. If the “OK” key 903 is pressed in this state, the registration period of one month is set in the setting contents of the RCP, and as well, “Registration Period: One Month” is recorded in the setting information 801 of the electronic data to be registered as shown in FIG. 8. Note that the registration period is not limited to the above period. For example, the registration period may be set by inputting the time period in a manner such as “yy:mm:dd”, or by specifying a last date of the time period.

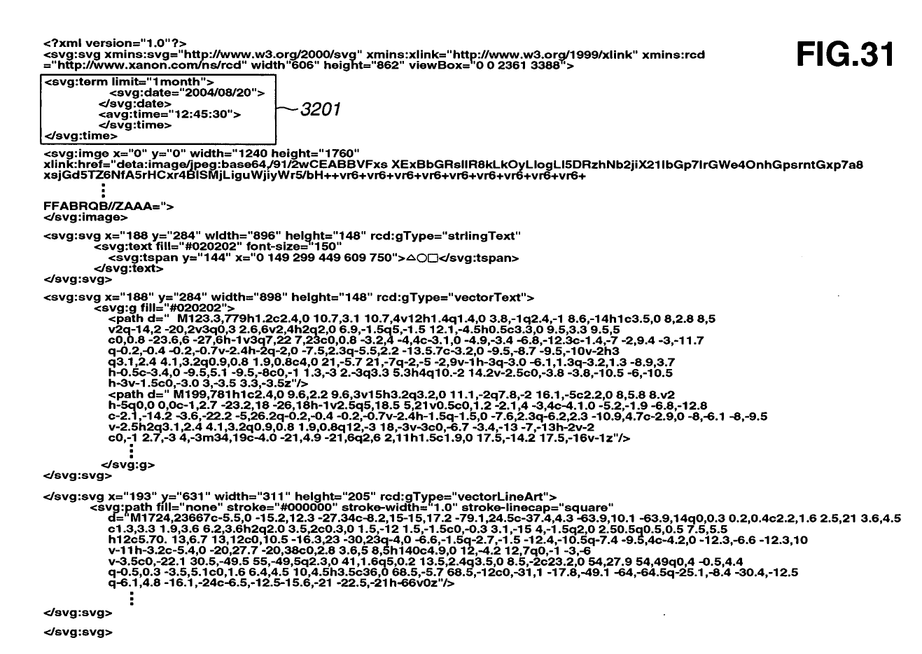

FIG. 31 is a diagram showing one example of vectorized data for which the registration period is specified. The vectorized data is represented in the SVG format, just as in the case of the first embodiment, however, the format of the vectorized data is not limited to this.

The descriptions as shown in FIG. 31 are similar the same as the descriptions as shown in FIG. 24, except that tags indicating the registration period as shown in a portion framed by a frame 3201 are added thereto. In this embodiment, a “date” tag and a “time” tag, which respectively indicate the date and the time of registration are set in a “term” tag that indicates the registration period. Of course, the descriptions are not limited to those as shown in FIG. 31, and other descriptions may be applied as long as the descriptions represents the registration period of the registration information.

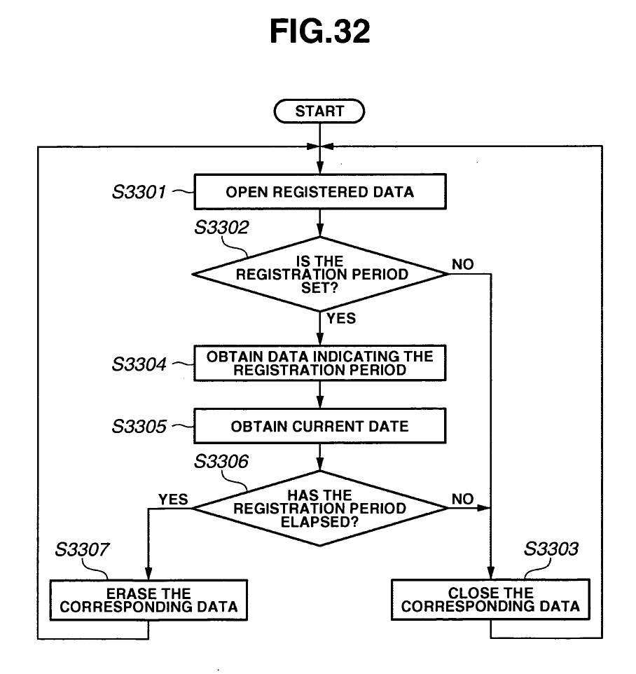

FIG. 32 is a flow chart that explains an exemplary management of the registration period performed by the database server 105. First, registered data is opened (step S3301), then whether the registration period is set is checked (step S3302), then, if the registration period is not set, the data is closed (step S3303), and after that, the processing returns to step S3301 to open next registered data. In an example as shown in FIG. 31, whether the registration period is set or not is determined based on whether the “term” tag is present or not.

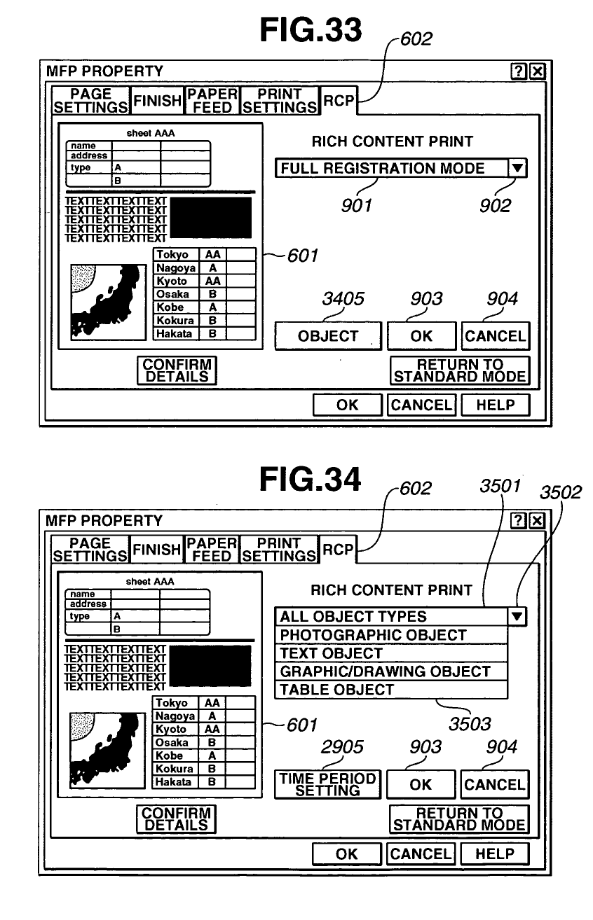

If the registration period is set, the data indicating the registration period (in the example as shown in FIG. 33, the parameters of the “term” tag and the “date” tag) is obtained from the data (step S3304), then a current date is obtained from an internal timer (not shown) of the database server 105 (step S3305), then a determination is made as to whether the registration period of the registered data has elapsed or not (step S3306), and then, the processing returns to step S3301 to open a next registration data. If it is determined that the registration period of the registered data has elapsed, the corresponding data is erased (step S3307) and then the processing returns to step S3301 to open next registered data.

Note that the management of the registration period as shown in FIG. 32 may preferably be carried out in a manner such that the date and time of registration that the database server 105 manages is referred to and the registered data is checked in an order of registration date and time. In addition, it is efficient if a flag is set to the registered data to which no registration period is set in order not to perform an unnecessary recheck. In this regard, a method of computing the registration period is as expressed by the equations below.
endtime=date(date)+date(term)
if today( )<endtime, the data is not erased (1)
if today( )≧endtime, the data is erased,
where date( ) is a function for converting a date character string into a date numerical value, and today ( ) is a function for obtaining a numerical value of a current date.

In this regard, the method of computation of the registration period is not limited to such simple comparison computation operation of the dates. That is, other comparison methods such as a method that utilizes an index for substituting the numerical value may be used.

### Fourth Exemplary Embodiment

Hereinbelow, the image processing according to a fourth embodiment of the present invention is explained. Note that in the fourth embodiment, with respect to configurations thereof that are similar to those in the first embodiment, the second embodiment and the third embodiment, the same reference numerals and symbols are provided thereto and a detailed explanation thereof is omitted.

In the third embodiment, an explanation is made as to an example in which the registered data is erased if it is determined that the registration period has elapsed. In the fourth embodiment, the explanation is made as to an example in which the registration period is set per object to be registered and if it is determined that the registration period has elapsed, an entity of the object is erased, so as to suppress the amount of registered data.

As described above, if the RCP is set in the print setting dialog as shown in FIG. 5, the “Detailed Settings” key 605 is made active, and further, the settings as to vectorization can be changed. FIGS. 33 and 34 are diagrams showing one example of a print setting dialog displayed when a “Detailed Settings” key 605 is pressed, according to the fourth embodiment of the present invention.

When an “Object” key 3405 in the user interface as shown in FIG. 33 is pressed, the user interface as shown in FIG. 34 is displayed, then a default object type or the currently-set object type is displayed in a box 3501. If a pull down arrow 3502 is pressed, as shown in FIG. 34, the object type that can be set is displayed in a pull down menu 3503.

The object type that can be set includes five different types such as “All Object Types”, “Photographic Object”, “Text Object”, “Graphic/Drawing Object”, and “Table Object”. In this regard, for example, if the type “Photographic Object” is selected, the selected type “Photographic Object” is displayed in the box 3501. If the “OK” key 903 is pressed in this state, the object type of photographic object is set in the setting contents of the RCP, and as well, “Object Type: Photographic Object” is recorded in the setting information 801 of the electronic data to be registered as shown in FIG. 8. Note that the registration period can be set per object type displayed in the box 3501 by pressing the “Time Period Setting” key 2905 as shown in FIG. 34. Further, the registration period of the object types to which no registration period is set is set to be a default period (for example, “Indefinite Period”). If “All Object Types” is selected and the registration period is set therefor, the setting is the same setting as in the third embodiment. Note that the setting of the registration period is similar to the third embodiment, and therefore the detailed explanation is omitted here.

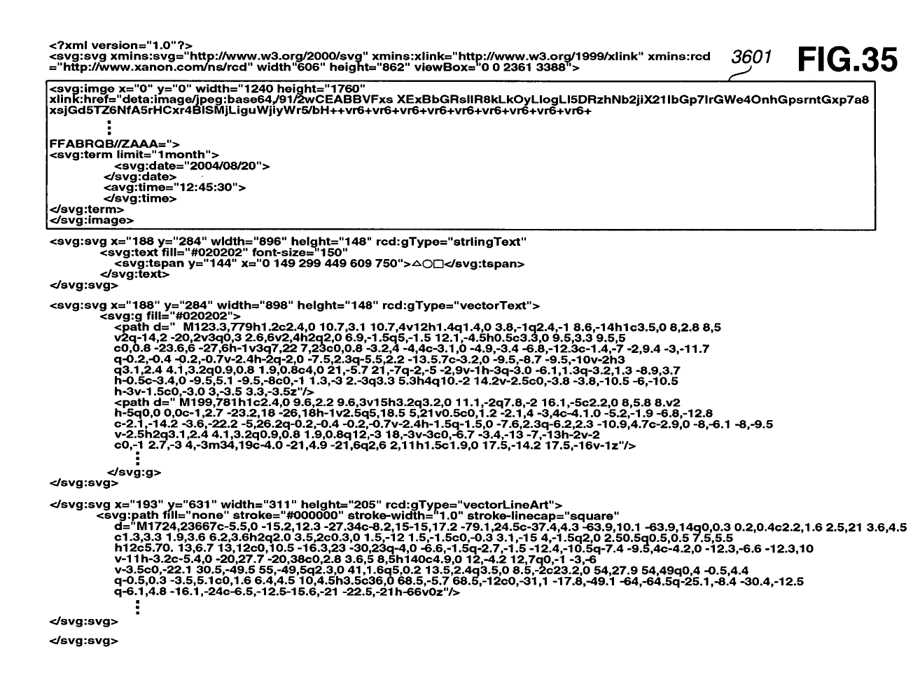

FIG. 35 is a diagram showing one example of the vectorized data for which the registration period of the photographic object is specified. The vectorized data is represented in the SVG format, just as in the case of the first embodiment, however, the format of the vectorized data is not limited to this.

The descriptions as shown in FIG. 35 are similar to the descriptions as shown in FIG. 24, except that tags indicating the object type and the registration period as shown in a portion framed by a frame 3601 are added thereto. In this embodiment, a “term” tag is set, just as in the case of the third embodiment, in an “image” tag that indicates the photographic object type. Of course, the descriptions are not limited to those as shown in FIG. 35, and other descriptions may be applied as long as the descriptions represents the registration period of the registration information.

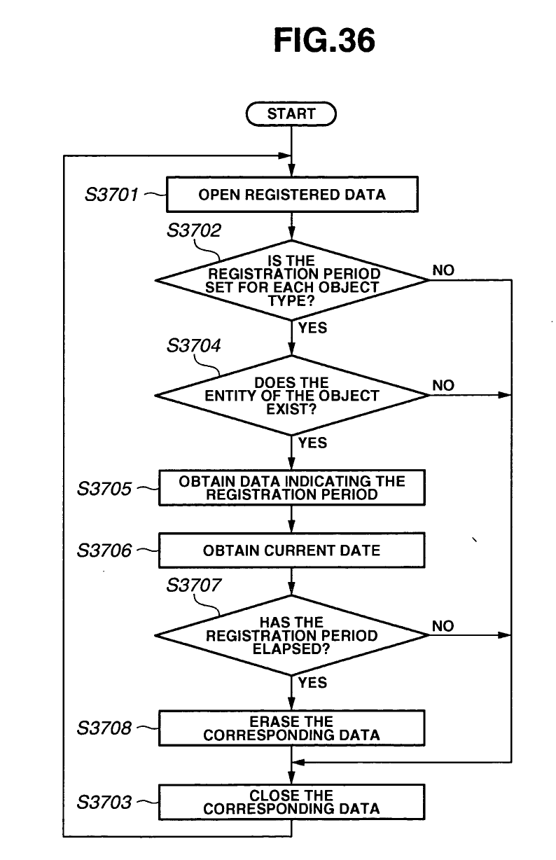

FIG. 36 is a flow chart that explains a management of the registration period performed by the database server 105. First, registered data is opened (step S3701), then whether the registration period per object type is set is checked (step S3702), then, if the registration period is not set, the data is closed (step S3703), and after that, the processing returns to step S3701 to open next registered data. In an example as shown in FIG. 31, whether the registration period is set per object type or not is determined based on whether the “image” tag including the “term” tag is present or not.

If the registration period is set per object type, whether there exists an entity of the object type in the corresponding data (step S3704), then if it is determined that there exists no such entity, the corresponding data is closed (step S3703), and then the processing returns to step S3701 to open next registered data.

If there exists an entity of the object of the corresponding object type, the data indicating the registration period (in the example as shown in FIG. 35, the parameters of the “term” tag and the “date” tag) is obtained (step S3705), then a current date is obtained from an internal timer (not shown) of the database server 105 (step S3706), then a determination is made as to whether the registration period of the registered data has elapsed or not (step S3707), and then, if it is determined that the registration period of the registered data has not elapsed, the corresponding data is closed (step S3703), and then the processing returns to step S3701 to open next registered data. If it is determined that the registration period of the registered data has elapsed, the object of the corresponding object type is erased from the corresponding data (step S3708), then, the corresponding data is closed (step S3703), and then the processing returns to step S3301 to open next registered data.

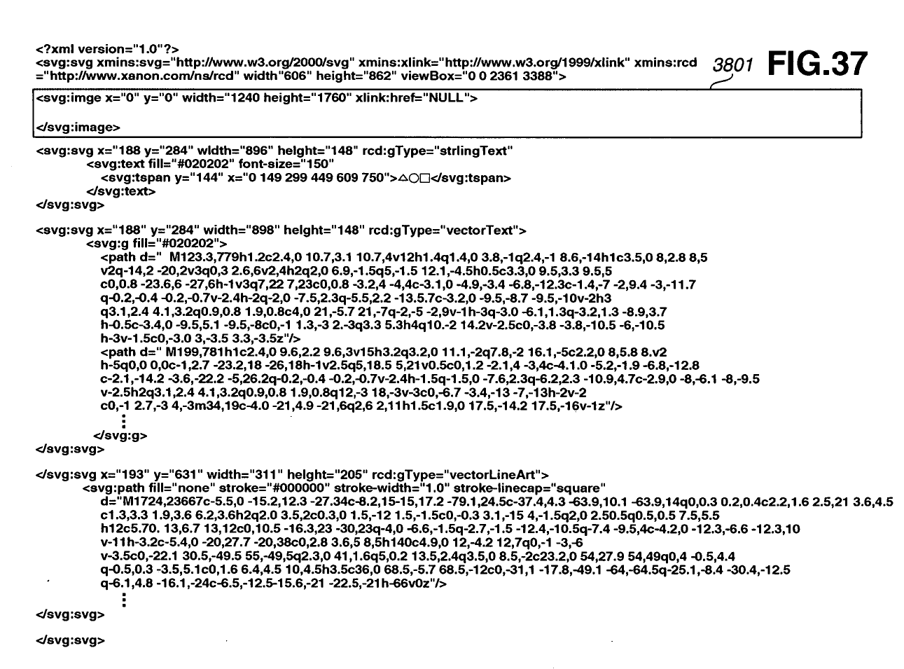

Note that the existence of the entity of the object means that the attribute of the object is not NULL. That is, as described in the first embodiment, in the case of the NULL state where only the area information is described, it is determined that there exists no such entity. Accordingly, erasure of the object by step S3708 means that the attribute of the object is made to be NULL, as shown as one example by the descriptions framed by a frame 3801 in FIG. 37.

### Fifth Exemplary Embodiment

Hereinbelow, the image processing according to a fifth embodiment of the present invention is explained. Note that in the fifth embodiment, with respect to configurations thereof that are similar to those in the first embodiment, the second embodiment, the third embodiment, and the fourth embodiment, the same reference numerals and symbols are provided thereto and a detailed explanation thereof is omitted.

In this regard, a method of suppressing the amount of registered data can be employed such that a frequency of access to the registered data is incorporated to the idea of erasing the registered data or the object as explained in the third and the fourth embodiments and the registered data or the object is erased in accordance with the access frequency recorded in the database server 105.

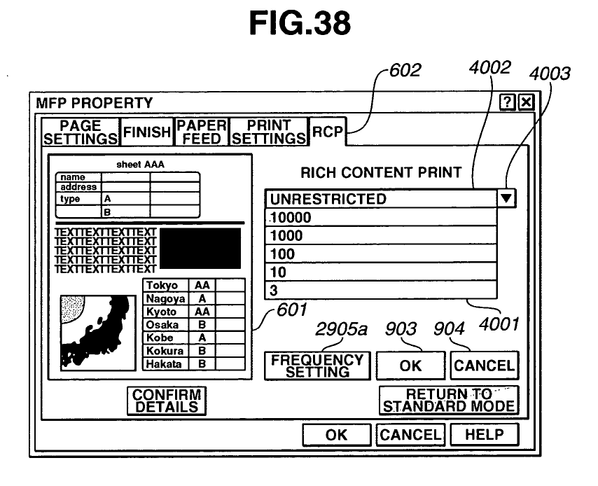

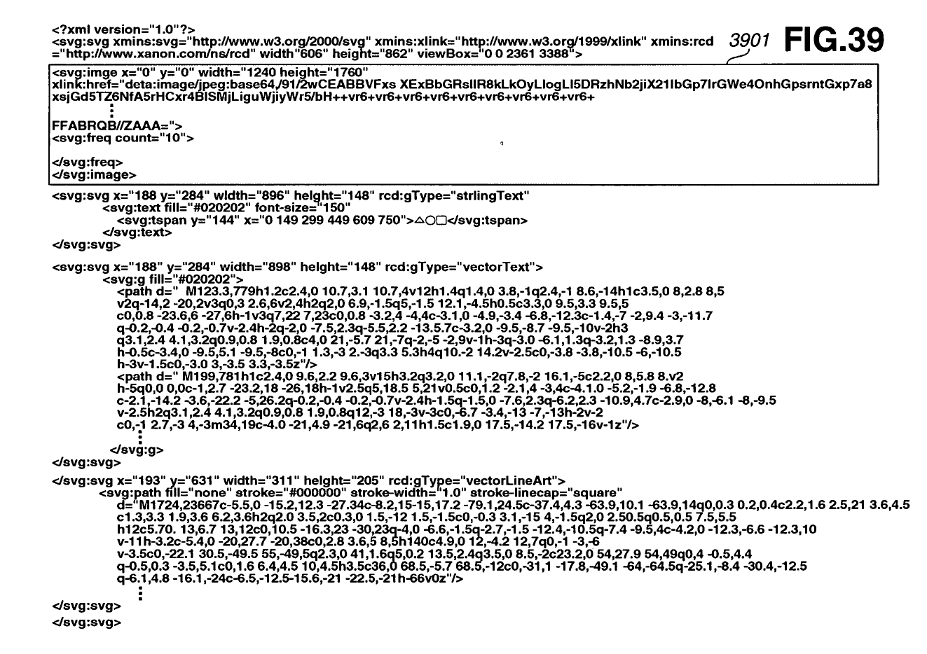

FIG. 38 is a diagram showing an example in which a “Frequency Setting” key 2905a is provided instead of the “Time Period Setting” key 2905, in the print setting dialog as shown in FIG. 34. When the “Frequency Setting”, key 2905a in the user interface as shown in FIG. 38 is pressed, a default access frequency or the currently-set access frequency (here, a unit of the frequency is, for example, access(es)/month) is displayed in a box 4002. If a pull down arrow 4003 is pressed, the access frequency that can be set is displayed in a pull down menu 4001.

The access frequency that can be set includes six different kinds of frequency such as “Unrestricted”, “10,000”, “1,000”, “100”, “10”, and “3”, for example. In this regard, for example, if the access frequency “100” is selected, the selected access frequency “100” is displayed in the box 4002. If the “OK” key 903 is pressed in this state, the access frequency of 100 is set in the setting contents of the RCP, and as well, “Access Frequency: 100” is recorded in the setting information 801 of the electronic data to be registered as shown in FIG. 8. Note that the access frequency is not limited to the above. That is, the access frequency may be input by using the keyboard.

FIG. 39 is a diagram showing one example of vectorized data for which the access frequency of the photographic object is specified. The vectorized data is represented in the SVG format, just as in the case of the first embodiment, however, the format of the vectorized data is not limited to this.

The descriptions as shown in FIG. 39 are similar to the descriptions as shown in FIG. 24, except that tags indicating the object type shown in a portion framed by a frame 3901 and the access frequency thereof are added thereto. In the example as shown in FIG. 39, a “freq” tag that indicates the access frequency is set in an “image” tag that indicates the photographic object type. Of course, the descriptions are not limited to those as shown in FIG. 39, and other descriptions may be applied as long as the descriptions represents the access frequency per object type.

In addition, the descriptions as shown in FIG. 39 are similar to the descriptions as shown in FIG. 24, except that tags indicating the registration period shown in a portion framed by a frame 3901 is added thereto. In this embodiment, the “date” tag and the “time” tag that respectively represent the date and time of registration are set in the “term” tag that indicates the registration period. Of course, the descriptions are not limited to those as shown in FIG. 31, and other descriptions may be applied as long as the descriptions represents the registration period of the registration information. In addition, just as in the case of the third embodiment, the access frequency may be set to the registered data, instead of setting the access frequency per object type.

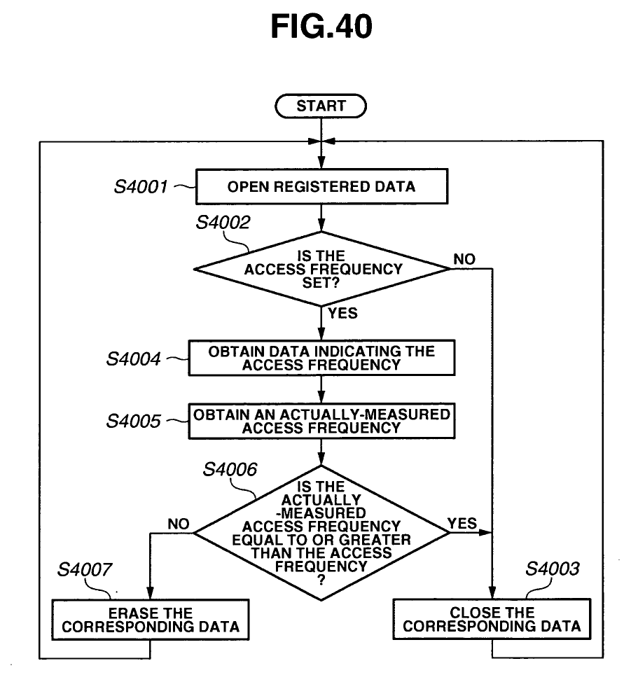

FIG. 40 is a flow chart that explains an exemplary management processing of the registration data performed by the database server 105. First, registered data is opened (step S4001). Then whether the access frequency is set to the corresponding data is checked (step S4002). If the access frequency is not set, the data is closed (step S4003). After that, the processing returns to step S4001 to open next registered data. In an example as shown in FIG. 39, whether the access frequency is set or not is determined based on whether the “freq” tag is present or not.

If the access frequency is set, the data indicating the access frequency (in the example as shown in FIG. 39, the parameters of the “freq” tag) is obtained (step S4004). Then, an actually-measured access frequency is obtained from the RAM, for example (step S4005). The actually-measured access frequency and the access frequency are compared to each other (step S4006). If the actually-measured access frequency is equal to or greater than the access frequency as a result of the comparison, the corresponding data is closed (step S4003). Then, the processing returns to step S4001 to open next registered data. If it is determined that the actually-measured access frequency is smaller than the access frequency, the corresponding data is erased (step S4007), and then the processing returns to step S4001 to open next registered data.

Other Exemplary Embodiments, Features and Aspects of the Present Invention

Note that the present invention may be applied to a system constituted by a plurality of devices (for example, a host computer, an interface device, a reader, a printer, and the like), or may be applied to an apparatus constituted by one single device (for example, a copying machine, a facsimile apparatus, and the like).

The aspect of the present invention can also be achieved by providing the system or the device with a storage medium (or a recording medium) which records a program code of software implementing the function of the embodiment and by reading and executing the program code stored in the storage medium with a computer of the system or the device (the CPU or the MPU). In this case, the program code itself, which is read from the storage medium, implements the function of the embodiment mentioned above, and accordingly, the storage medium storing the program code constitutes the present invention. In addition, the function according to the embodiments described above is implemented not only by executing the program code read by the computer, but also implemented by the processing in which an OS (operating system) or the like carries out a part of or the whole of the actual processing on the basis of the instruction given by the program code.

Further, in another aspect of the embodiment of the present invention, after the program code read from the storage medium is written in a function enhancing board inserted in the computer or a memory which is provided in a function enhancing unit connected to the computer, the CPU and the like provided in the function enhancing board or the function enhancing unit carries out a part of or the whole of the processing to implement the function of the embodiment as described above.

When the present invention is applied to the storage medium, the storage medium stores the program code corresponding to the flow chart as explained above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-084514 filed Mar. 23, 2005, which is hereby incorporated by reference herein in its entirety.

What is claimed is:

1. An image processing apparatus comprising:
a print instruction unit configured to instruct printing of application data;
a registration setting unit configured to register as to whether the application data is registered to a database;
an attribute selection unit configured to select an attribute of data to be registered to the database when a registration is set by said registration setting unit, the attribute including a type of data;
a conversion unit configured to convert the application data, which have the attribute selected by said attribute selection unit, into data to be registered of another data format; and
a registration unit configured to register the data converted by said conversion unit into the database when the registration is set by the registration setting unit.

2. The image processing apparatus according to claim 1, wherein the selected attribute is a type of an object.

3. The image processing apparatus according to claim 1, wherein said registration unit registers the converted data with the application data.

4. The image processing apparatus according to claim 1, further comprising a time period setting unit configured to set a time period of registration of the converted data,
wherein said registration unit registers the converted data with data of the registration period set by said time period setting unit.

5. The image processing apparatus according to claim 4, wherein the time period setting unit sets the registration period for each attribute.

6. The image processing apparatus according to claim 5, wherein an entity of the object corresponding to the attribute whose registration period has already elapsed is erased from the data registered to the database.

7. The image processing apparatus according to claim 1, further comprising an access frequency setting unit configured to set an access frequency for erasing the registered data from the database,
wherein said registration unit registers the converted data with data of the access frequency set by said access frequency setting unit.

8. The image processing apparatus according to claim 7, wherein the registered data that is smaller than the access frequency set by said access frequency setting unit is erased from the database.

9. The image processing apparatus according to claim 7, wherein said access frequency setting unit sets the access frequency with respect to each attribute.

10. The image processing apparatus according to claim 1, wherein said conversion unit converts the application data having the attribute into vector data.

11. An image processing method of an image processing apparatus having a print instruction unit configured to instruct printing of application data, the method comprising:
setting whether the application data is registered to a database;
selecting an attribute of data to be registered to the database when a registration is set, the attribute including a type of data;
converting the application data, which have the attribute selected, into data to be registered of another data format; and
registering the converted data into the database when the registration is set.

12. A computer-executable program for controlling an image processing apparatus, the computer-executable program comprising:
computer-executable instructions for setting whether application data is registered to a database;
computer-executable instructions for selecting an attribute of data to be registered to the database when a registration is set, the attribute including a type of data;
computer-executable instructions for converting the application data, which have the attribute selected, into data to be registered of another data format; and
computer-executable instructions for registering the data converted into the database when the registration is set.

13. An image processing apparatus for processing image data, the apparatus comprising:
an attribute selection unit configured to select an attribute to be registered to a database based on user's instruction, the attribute including a type of data;
a conversion unit configured to convert an area of the image data into object data to be registered, wherein the area of the image data have the attribute selected by said attribute selection unit; and
an output unit configured to output the object data converted by said conversion unit to the database for the registration.

14. An image processing method for processing image data comprising:
selecting an attribute to be registered to a database based on user's instruction, the attribute including a type of data;
converting an area of the image data into object data to be registered, wherein the area of the image data have the attribute selected; and
outputting the object data converted by the conversion unit to the database for the registration.

15. A computer-readable recording medium containing computer-executable instructions for executing:
an attribute selection step for selecting an attribute to be registered to a database based on user's instruction, the attribute including a type of data;
a conversion step for converting an area of image data into object data to be registered, wherein the area of the image data have the attribute selected in said attribute selection step; and
an output step for outputting the object data converted by said conversion unit to the database for the registration.
